(19) United States
(12) Patent Application Publication
(10) Pub. No.: US 2026/0133859 A1
(43) Pub. Date: May 14, 2026

(54) Small Language Models For In-Vehicle Function-Calling

(71) Applicant: Mercedes-Benz Group AG, Stuttgart (DE)

(72) Inventors: Farris Atif, Alamo, CA (US); Immanuel Baur, San Francisco, CA (US); Benedikt Heidrich, Karlsruhe (DE); Chieh Hsu, Santa Clara, CA (US); Sebastian Kramer, Karlsruhe (DE); Julian Merten, Mountain View, CA (US); Tobias Michels, Eggenstein-Leopoldshafen (DE); Muhammad Saquib Sarfraz, Eggenstein-Leopoldshafen (DE); Yahya Sowti Khiabani, Fremont, CA (US); Sven Stahlmann, Köln (DE); Moritz Strenger, Karlsruhe (DE); Faezeh Tafazzoli, San Jose, CA (US)

(21) Appl. No.: 19/374,727

(22) Filed: Oct. 30, 2025

Related U.S. Application Data
(60) Provisional application No. 63/713,943, filed on Oct. 30, 2024.

(51) Int. Cl. G06F 9/54

(52) U.S. Cl. CPC G06F 9/547

(57) ABSTRACT

Methods, computing systems, and technology for enabling function-calling in a vehicle using a small language model (SLM) are disclosed. A computing system may be configured to access a pretrained SLM and prune the pretrained SLM by at least one of depth-wise pruning or width-wise pruning to generate a compressed SLM. The computing system may be configured to recover the compressed SLM to restore at least one of linguistic coherence or factual performance. The computing system may be further configured to convert the compressed SLM into a quantized runtime format executable on in-vehicle hardware. The quantized SLM may be used to process natural-language inputs and generate one or more function-calling outputs corresponding to vehicle control commands.

### CROSS-REFERENCE TO RELATED APPLICATIONS

The present application claims the benefit of and the priority to U.S. Provisional Application No. 63/713,943, filed Oct. 30, 2024. U.S. Provisional Application No. 63/713,943 is hereby incorporated by reference in its entirety.

### FIELD

The present disclosure relates to methods, systems, and computer program products for deploying Small Language Models within a vehicle.

### BACKGROUND

Small language models (SLMs) are artificial intelligence models with less parameters than large language models (LLMs). SLMs can be trained to perform specific tasks using fewer resources than larger models.

### SUMMARY

Aspects and advantages of implementations of the present disclosure will be set forth in part in the following description, or may be learned from the description, or may be learned through practice of the implementations.

One example aspect of the present disclosure is directed to a computing system of a vehicle. The computing system includes a control circuit configured to access a pretrained small language model, prune the pretrained small language model by at least one of depth-wise pruning or width-wise pruning to generate a compressed small language model, recover the compressed small language model to restore at least one of linguistic coherence or factual performance, and convert the compressed small language model into a quantized runtime format executable on in-vehicle hardware.

One example aspect of the present disclosure is directed to a computer-implemented method. The computer-implemented method includes a computer-implemented method for in-vehicle function-calling using a small language model. The method can include accessing a pretrained small language model, pruning the pretrained small language model by at least one of depth-wise pruning or width-wise pruning to generate a compressed small language model, recovering the compressed small language model to restore at least one of linguistic coherence or factual performance, and converting the compressed small language model into a quantized runtime format executable on in-vehicle hardware for calling one or more functions.

One example aspect of the present disclosure is directed to one or more non-transitory computer-readable media that store instructions that are executable by a control circuit to: access a pretrained small language model, prune the pretrained small language model by at least one of depth-wise pruning or width-wise pruning to generate a compressed small language model, recover the compressed small language model to restore at least one of linguistic coherence or factual performance, and convert the compressed small language model into a quantized runtime format executable on in-vehicle hardware.

Other example aspects of the present disclosure are directed to other systems, methods, vehicles, apparatuses, tangible non-transitory computer-readable media, and devices for the technology described herein.

These and other features, aspects, and advantages of various implementations will become better understood with reference to the following description and appended claims. The accompanying drawings, which are incorporated in and constitute a part of this specification, illustrate implementations of the present disclosure and, together with the description, serve to explain the related principles.

Other example aspects of the present disclosure are directed to other systems, methods, vehicles, apparatuses, tangible non-transitory computer-readable media, and devices for the technology described herein.

These and other features, aspects, and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 illustrates an example computing ecosystem according to an embodiment hereof.

FIGS. 2A-D illustrate diagrams of an example computing architecture for an onboard computing system of a vehicle according to an embodiment hereof.

FIG. 3 illustrates an example vehicle interior with an example display according to an embodiment hereof.

FIG. 4 illustrates a diagram of an example computing platform that is remote from a vehicle according to an embodiment hereof.

FIG. 5 illustrates a diagram of an example user device according to an embodiment hereof.

FIG. 6A illustrates an example dataflow pipeline according to an embodiment hereof.

FIG. 6B shows an example heatmap of distances for 32 decoder layers of an example SLB, according to some embodiments.

FIG. 7 illustrates a flowchart diagram of an example method according to an embodiment hereof.

FIG. 8 illustrates a diagram of an example computing ecosystem with computing components according to an embodiment hereof.

### DETAILED DESCRIPTION

The present disclosure relates to method, system, and computer program product for deploying Small Language Models (SLMs, also referred as base model or model) as function-calling agents within a vehicle (e.g., edge device), offering a more flexible and robust alternative to rule-based systems. By using SLMs, the present disclosure describes embodiments that simplify vehicle control mechanisms and the user experience.

Various embodiments of the present disclosure include applying model compression techniques, such as, pruning, healing, and quantization. These techniques can promote a model that fits within the resource limitations for the vehicle while maintaining a minimum acceptable level of performance. An example embodiment of the present invention includes selecting and modifying a representative SLM, such as, Microsoft's Phi-3 mini, and enabling embedded models, including compression, task-specific fine-tuning, and/or vehicle integration.

In some implementations, the system handles complex in-vehicle tasks accurately and efficiently despite significant reduction in model size compared to large language models (LLMs) or even conventional SLMs. Additionally or alternatively, using the SLMs, the present disclosure can use one or more SLMs to manage and/or govern vehicle control systems. Thus, the systems described herein can allow for improved intuitive interactions between users and vehicles for an improved driving experience.

According to an example embodiment of the present disclosure, the system can deploy one or more SLMs for in-vehicle function-calling. This includes taking a SLM model and then applying the steps related to pruning, healing, and function-calling alignment. This is carried out to improve existing SLMs by further reducing their size and/or fine-tuning them to maintain performance on domain-specific tasks, including example vehicle related functions. For example, this could be performed by using advanced model compression techniques such as pruning, quantization, and/or lightweight runtime execution.

In some implementations, function-calling capabilities in a vehicle can be improved using a retrieval method. For example, SLMs can be improved to control various in-vehicle functions, such as seat heating, ambient lighting, and/or local climate. This provides dynamic control of vehicle settings, thereby reducing manual intervention and allowing seamless software updates.

In some implementations, the present disclosure provides a robust “healing” or recovering process. This process of recovering or healing can include one or more of full fine-tuning (FFT) and/or supervised fine-tuning (SFT). Additionally or alternatively, the process can include using special tokens to represent in-vehicle function calls and/or aligning the pruned and healed model with in-vehicle function-calling tasks. In some embodiments, the model may be pruned and/or healed, for example, using similarity-based depth-wise pruning and/or width-wise pruning.

Additionally or alternatively, healing techniques can be used to reduce the size of SLM model. For example, a Phi-3 mini model can be pruned while maintaining acceptable performance across both general and domain-specific tasks. Additionally or alternatively, the model may be fine-tuned for in-vehicle function-calling. For example, the pruned and healed model may be fine-tuned using a custom dataset for in-vehicle function-calling and/or incorporating specialized tokens to map language model outputs to gRPC-based vehicle functions. In some embodiments, an inference framework or library may be used for model conversion and/or quantization. The inference framework can allow for efficient deployment on resource-constrained vehicle hardware. This approach helps ensure that the language model (e.g., SLM) can operate in real-time environments with limited computational resources.

In some embodiments, a SLM, which is a decoder-only transformer language model with L=32 hidden layers, can be used. The SLM may be selected due to its small size of 3.8B parameters while simultaneously having relatively strong performance across public benchmarks and/or an ability to run across various software stacks. In some embodiments, the SLM selected may have fewer than 4.0B parameters.

In some embodiments, both width and depth pruning can produce two different variants of the original SLM: SLM-2.8B and SLM-1.8B. Table 1 below contains details regarding an example architecture of the two variants and the original Phi3-mini.

TABLE 1
Model architecture details for original
SLM-mini and its pruned variants.

| | | | Hidden | MLP | Attention |
|---|---|---|---|---|---|
| Model | Parameter | # Layers | dim | dim | heads |
| SLM-mini | 3.8B | 32 | 3072 | 8192 | 32 |
| SLM-2.8B | 2.8B | 24 | 3072 | 8192 | 32 |
| SLM-1.8B | 1.8B | 32 | 2688 | 5120 | 28 |

As shown in Table 1, SLM-2.8B represents the result of dropping layers 21 to 29. Let hi represent the i-th hidden state of the model and n the chosen block size. Then, for all i∈{1, . . . , L−n}, where L is the number of hidden layers in the model, the angular distance between hidden states can be described as

$$d ( {h}_{i} , {h}_{i + n} ) := arccos ( \frac{〈 {h}_{i} , {h}_{i + n} 〉}{‖ {h}_{i} ‖ ‖ {h}_{i + n} ‖} ) \qquad ( 1 )$$

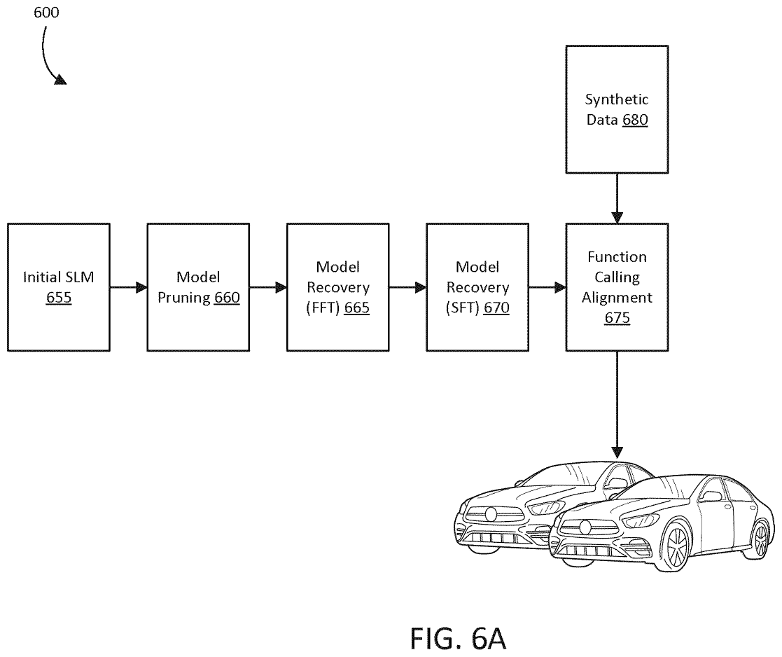

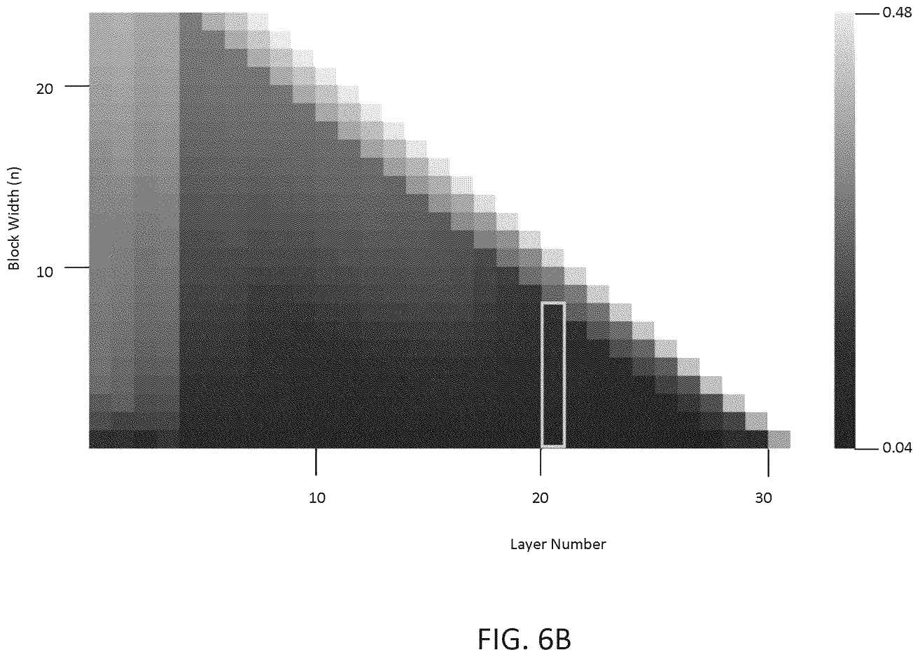

Equation (1) can be used to compute distances for different block sizes calculated against the dataset. Dropping more than 30% of the layers across different model families can result in collapse or overly rapid degradation of the original SLM. As a result, pruning a contiguous block of size n=8 can minimize this cumulative layer distance. FIG. 6B shows an example heatmap of distances for 32 decoder layers of an example SLB, with varying block sizes n∈{1, . . . , 24}, calibrated with a fineweb dataset. Darker grays indicate regions of minimum distance or maximum similarity. Layers 21-29 (highlighted in a rectangle) were found to be the optimal block of size n=8 to prune in this embodiment. In some embodiments, the SLM is not pruned more than a threshold number and/or percent of layers. The threshold number and/or percent can correspond, for example, to 30% of the layers.

As shown in Table 1, SLM-1.8B was then created by applying the width pruning approach to SLM-2.8B by recording activations on each layer (block) in the same manner as the depth-wise approach.

For the attention heads, the L₂-norm can be calculated along the head dimension. The mean across the sequence and batch dimensions for all activations can then be calculated. This gives a score for each hidden neuron, each neuron in the intermediate layer of the multi-layer perceptron (MLP), and each attention head. The neurons and/or attention heads with the lowest score can be pruned. For example, the hidden dimension may be pruned from 3072 to 2688, the MLP dimension from 8192 to 5120, and/or the number of attention heads from 32 to 28. These proportions and/or numbers may represent minimum and/or thresholds for pruning of hidden dimensions, MLP dimensions, and/or attention heads, respectively.

Because resulting models may struggle to generate coherent sentences and/or may lose their alignment, the model may then undergo healing and/or recovery training. In some embodiments, the model may be trained with at least 5000 steps using, for example, Quantized Low-Rank Adapter (QLoRA) fine-tuning on only the MLP weights with a diverse web-scale dataset, for which a training dataset may be used. The models produced by this step may be denoted with hₛₕₒᵣₜ. It may not be sufficient to fully recuperate the model without further action to cause the model to form correct and/or meaningful sentences again. After pruning, the factual knowledge of the original model may be almost entirely lost. With continued training of the pruned models on, for example, datasets for another 45000 steps/15B tokens, the system may be able to form correct and/or meaningful sentences again. This healed or recovered SLM may be denoted as h_{long}. In some embodiments, the pruned SLM may be healed for at least 10B tokens.

In some embodiments, the healed SLM may be tuned for at least one epoch on, for example, the OpenHermes-2.5 dataset. As described herein, such resulting models may be marked with SFT (Supervised Fine-Tuning). The SLM-1.8B model, for example, may be healed to the pruned SLM-2.8B model before a width-pruning step. For example, the SLM-2.8B+h_{long} model may be used as the base model and then receive width pruning and instruction fine-tuning (SFT) on top of that.

Both full fine-tuning (FFT) and LoRA may be used in some embodiments. FFT offers comprehensive model adaptation but can be computationally expensive, while LoRA provides a more parameter-efficient alternative, particularly beneficial when GPU resources are limited. LoRA's ability to extend model functionalities provides significant potential for adapting the embodiments described herein to a wide range of applications. In addition to being more computationally efficient, the modularity of LoRA adapters opens up the possibility of seamlessly switching between different adapters, allowing for dynamic customization and adaptation of the model to various tasks or domains. The pruned and healed SLM model can be fine-tuned to enhance its function-calling capabilities for in-vehicle operations.

Additionally or alternatively, a synthetic dataset can be generated for integrating functional tokens into the tokenizer. In some embodiments, a plurality of tokens can be defined for specific vehicle functions, such as set_ambient_light_color_program mapped to <MB_1> and set_seat_heating_intensity mapped to <MB_2>. A multi-step prompt design for generating positive and negative examples can be used to promote diversity and/or naturalness.

With reference to positive examples, a prompt template can be used to generate realistic in-vehicle voice commands based on predefined vehicle functions. For instance, a query like “Warm up my seat and set the mood to Malibu Sunset before I get in the car” may generate:
<MB_2> (seat_position=“FRONT_LEFT”, intensity=3);
<MB_1> (color_program=“MalibuSunset”);
<MB_O> (message=“I've warmed up your seat and set the ambient lighting to Malibu Sunset. Your car will be inviting when you get in.”)<MB_end>

In some embodiments, at least a minimum number (e.g., 25,000) of examples may be generated for use across one or more vehicle functions.

With reference to negative examples, a threshold minimum (e.g., at least 500) irrelevant queries may be generated using a negative sampling strategy. Such queries may include plausible but unsolvable queries provided by the functions (e.g., “Can you teleport the car to Hawaii?”). The unsolvable queries may include queries that cannot be resolved using conventional tools within vehicle. The assistant can be trained to respond by politely declining the request.

The SLM may undergo one or more steps of quality control. For example, a subset of examples derived from common user questions may be manually and/or automatically curated and included in the prompt to the LLM to promote more life-like datasets that reflect real-life spoken user queries. Additionally or alternatively, function calls may be evenly distributed across different functions of the vehicle to avoid imbalance. In some embodiments, specific rules can be added to the prompts to ensure high-quality dataset generation. The dataset can be developed to reflect natural in-vehicle commands to improve accuracy in function-calling and/or robustness to unsupported queries.

In some embodiments, a 2.8B and/or 1.8B pruned models may be fine-tuned using LoRA fine-tuning and/or full fine-tuning. Example specific settings are outlined in Table 2. In some embodiments, an original SLM can be tuned using LoRA. In some embodiments, FFT may be applied to training of a single epoch. Additionally or alternatively, a smaller learning rate with a weight decay of 0.1 may be used. These approaches may help prevent overfitting to the function-calling dataset, which is a common concern with FFT due to its tendency to aggressively adapt to the training data.

In some embodiments, LoRA fine-tuning may use at least two epochs of training, may be trained without any weight decay, and/or may be trained with a larger learning rate. These parameters may achieve a minimum threshold of results on function-calling tests. This may be because LoRA can introduce a smaller set of trainable parameters compared to FFT. Additionally or alternatively, LoRA may necessitate more training epochs (e.g., greater than 1, 2, or more) and/or a higher learning rate than other tuning methods, in order to effectively capture the nuances of the function-calling task.

The inference framework can include a tensor library and file format. The inference framework can be a wrapper around the ggml tensor library, which has native support for transformer model operations. The gguf file format can be used to serialize language models and/or respective metadata (e.g., tokenizer, model type, quantization, etc.) into a single artifact. The single artifact can be executed against the ggml tensor library. It is flexible in its implementation and operations can be removed or composed depending on the model graph being executed.

In some embodiments, the system can merge LoRA into a base model (e.g., if LORA is used), convert safetensors artifact to gguf, quantize resulting gguf to 4-bit, test resulting artifact, and/or quantify distance between gguf and original safetensors implementation.

In some embodiments, gguf artifacts can be quantized to a level ranging from 2-bit to 8-bit. For example, in some embodiments, a 4-bit quantization may be selected. This quantization range can balance token throughput and/or generation with minimal added perplexity. Additionally or alternatively, in this format a pruned SLM uses less than a threshold amount (e.g., 2 Gb) of RAM.

An aspect of the present disclosure relates to a method, system, and computer program product for enabling in-vehicle function-calling through deployment of small language models (SLMs) as function-calling agents. The disclosed technology improves vehicle computing systems by compressing, retraining, and/or quantizing pretrained language models so that they can operate efficiently on constrained automotive hardware. In particular, the system allows for natural-language control of in-vehicle functions such as seat heating, ambient lighting, or local climate management, replacing conventional rule-based control interfaces with flexible model-based inference.

For example, an in-vehicle assistant may receive a voice prompt (e.g., “Warm up my seat and set the mood to Malibu Sunset”). Traditional vehicle control systems rely on explicit command parsing or rigid function mappings that fail to generalize across diverse user expressions. By contrast, the disclosed systems can employ a pruned and/or healed/recovered SLM that interprets such input as a sequence of function calls corresponding to executable vehicle actions. The SLM may output tokens representing distinct control operations, each mapped to a gRPC or similar interface of the vehicle's control architecture.

As discussed above, the technology can apply a combination of pruning, recovery, and quantization techniques to a SLM. Depth-wise and/or width-wise pruning may be performed to remove redundant model layers and/or attention heads (respectively) based on similarity metrics such as angular distance between hidden states and/or magnitude of neuron activations. These steps produce a compact model with fewer parameters while preserving representational capacity. After pruning, the model can be retrained or “healed” using supervised or full fine-tuning on large-scale general and domain-specific datasets to restore linguistic coherence and factual accuracy.

Once recovered, the SLM may be fine-tuned for in-vehicle tasks using datasets that integrate special-function tokens representing individual vehicle functions. Positive and/or negative examples may be generated to train the model to distinguish valid in-vehicle commands from unsupported requests. For instance, a valid request such as “Turn on the cabin lights” may map to a predefined function token (e.g., <MB₁>), while an implausible query such as “Fly to Paris” may be used to train the model to decline politely. These curated examples allow the model to interpret varied natural-language inputs while maintaining safe and predictable behavior.

In some embodiments, low-rank adaptation (LoRA) or quantized LoRA (QLORA) fine-tuning is applied to improve specificity for in-vehicle contexts while maintaining efficiency. The trained SLM is then converted into a quantized runtime format, such as a 4-bit gguf artifact compatible with one or more lightweight inference libraries. Use of a higher degree of compression may result in a significant drop in model performance. This quantized artifact can execute locally within the vehicle's control hardware using limited memory (e.g., under 2 GB of RAM) while achieving acceptable inference latency. By compressing and adapting pretrained language models in this way, the disclosed system can enable natural-language vehicle control that is both resource-efficient and responsive to user intent. For example, when generating a special-function token (e.g., <MB_1> for seat heating), the model can be tuned using a low-rank adaptation technique (e.g., LoRA) so that it becomes more accurate for domains like specific in-vehicle command.

By reducing model complexity and energy consumption while enhancing interpretability and responsiveness, the disclosed embodiments improve both computational efficiency and user experience in modern vehicle environments. The resulting in-vehicle assistant can operate without reliance on cloud inference, allowing for greater privacy, reduced latency, and/or continuous function even in low-connectivity conditions. In this manner, the present disclosure provides an effective framework for integrating compact, language-based control systems directly within vehicle computing architectures.

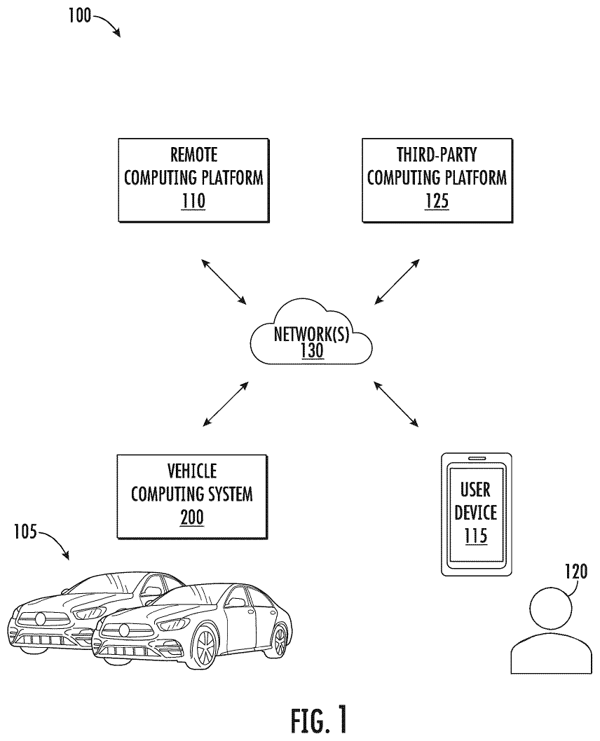

FIG. 1 illustrates an example computing ecosystem 100 according to an embodiment hereof. The ecosystem 100 may include a vehicle 105, a remote computing platform 110 (also referred to herein as computing platform 110), and a user device 115 associated with a user 120. The user 120 may be the owner of the vehicle. In some implementations, the user 120 may be a user intending to operate the vehicle. In some implementations, the computing ecosystem 100 may include a third party (3P) computing platform 125, as further described herein. The vehicle 105 may include a vehicle computing system 200 located onboard the vehicle 105. The computing platform 110, the user device 115, the third party computing platform 125, and/or the vehicle computing system 200 may be configured to communicate with one another via one or more networks 130.

The systems/devices of ecosystem 100 may communicate using one or more application programming interfaces (APIs). This may include external facing APIs to communicate data from one system/device to another. The external facing APIs may allow the systems/devices to establish secure communication channels via secure access channels over the networks 130 through any number of methods, such as web-based forms, programmatic access via RESTful APIs, Simple Object Access Protocol (SOAP), remote procedure call (RPC), scripting access, etc.

The computing platform 110 may include a computing system that is remote from the vehicle 105. In an embodiment, the computing platform 110 may include a cloud-based server system. The computing platform 110 may be associated with (e.g., operated by) an entity. For example, the remote computing platform 110 may be associated with an OEM that is responsible for the make and model of the vehicle 105. In another example, the remote computing platform 110 may be associated with a service entity contracted by the OEM to operate a cloud-based server system that provides computing services to the vehicle 105.

The computing platform 110 may include one or more back-end services for supporting the vehicle 105. The services may include, for example, tele-assist services, navigation/routing services, performance monitoring services, Large Language Models (LLMs), Small Language Models (SLMs), etc. The computing platform 110 may host or otherwise include one or more APIs for communicating data to/from a computing system of the vehicle 105 (e.g., vehicle computing system 200) or the user device 115. The computing platform 110 may include one or more inter-service APIs for communication among its microservices. In some implementations, the computing platform may include one or more RPCs for communication with the user device 115.

The computing platform 110 may include one or more computing devices. For instance, the computing platform 110 may include a control circuit and a non-transitory computer-readable medium (e.g., memory). The control circuit of the computing platform 110 may be configured to perform the various operations and functions described herein. Further description of the computing hardware and components of computing platform 110 is provided herein with reference to other figures.

The user device 115 may include a computing device owned or otherwise accessible to the user 120. For instance, the user device 115 may include a phone, laptop, tablet, wearable device (e.g., smart watch, smart glasses, headphones), personal digital assistant, gaming system, personal desktop devices, other hand-held devices, or other types of mobile or non-mobile user devices. As further described herein, the user device 115 may include one or more input components such as buttons, a touch screen, a joystick or other cursor control, a stylus, a microphone (e.g., voice commands), a camera or other imaging device, a motion sensor (e.g., physical commands), etc. The user device 115 may include one or more output components such as a display device (e.g., display screen), a speaker, etc.

In an embodiment, the user device 115 may include a component such as, for example, a touchscreen, configured to perform input and output functionality to receive user input and present information for the user 120. The user device 115 may execute one or more instructions to run an instance of a software application and present user interfaces associated therewith, as further described herein. In an embodiment, the launch of a software application may initiate a user-network session with the vehicle computing system 200, computing platform 110, etc.

The third-party computing platform 125 may include a computing system that is remote from the vehicle 105, remote computing platform 110, and user device 115. In an embodiment, the third-party computing platform 125 may include a cloud-based server system. The term “third-party entity” may be used to refer to an entity that is different than the entity associated with the remote computing platform 110. For example, as described herein, the remote computing platform 110 may be associated with an OEM that is responsible for the make and model of the vehicle 105. The third-party computing platform 125 may be associated with a supplier of the OEM, a maintenance provider, a mapping service provider, an emergency provider, or other types of entities. In another example, the third-party computing platform 125 may be associated with an entity that owns, operates, manages, etc. a software application that is available to or downloaded on the vehicle computing system 200.

The third-party computing platform 125 may include one or more back-end services provided by a third-party entity. The third-party computing platform 125 may provide services that are accessible by the other systems and devices of the ecosystem 100. The services may include, for example, mapping services, routing services, search engine functionality, maintenance services, entertainment services (e.g., music, video, images, gaming, graphics), emergency services (e.g., roadside assistance, 911 support), open sourced/commercial LLMs, or other types of services. The third-party computing platform 125 may host or otherwise include one or more APIs for communicating data to/from the third-party computing system 125 to other systems/devices of the ecosystem 100.

The networks 130 may be any type of network or combination of networks that allows for communication between devices. In some implementations, the networks 130 may include one or more of a local area network, wide area network, the Internet, secure network, cellular network, mesh network, peer-to-peer communication link or some combination thereof and may include any number of wired or wireless links. Communication over the networks 130 may be accomplished, for instance, via a network interface using any type of protocol, protection scheme, encoding, format, packaging, etc. In an embodiment, communication between the vehicle computing system 200 and the user device 115 may be facilitated by near field or short range communication techniques (e.g., Bluetooth low energy protocol, radio frequency signaling, NFC protocol).

The vehicle 105 may be a vehicle that is operable by the user 120. In an embodiment, the vehicle 105 may be an automobile or another type of ground-based vehicle that is manually driven by the user 120. For example, the vehicle 105 may be a Mercedes-Benz® car or van. In some implementations, the vehicle 105 may be an aerial vehicle (e.g., a personal airplane) or a water-based vehicle (e.g., a boat). The vehicle 105 may include operator-assistance functionality such as cruise control, advanced driver assistance systems, etc. In some implementations, the vehicle 105 may be a fully or semi-autonomous vehicle.

The vehicle 105 may include a powertrain and one or more power sources. The powertrain may include a motor (e.g., an internal combustion engine, electric motor, or hybrid thereof), e-motor (e.g., electric motor), transmission (e.g., automatic, manual, continuously variable), driveshaft, axles, differential, e-components, gear, etc. The power sources may include one or more types of power sources. For example, the vehicle 105 may be a fully electric vehicle (EV) that is capable of operating a powertrain of the vehicle 105 (e.g., for propulsion) and the vehicle's onboard functions using electric batteries. In an embodiment, the vehicle 105 may use combustible fuel. In an embodiment, the vehicle 105 may include hybrid power sources such as, for example, a combination of combustible fuel and electricity.

The vehicle 105 may include a vehicle interior. The vehicle interior may include the area inside of the body of the vehicle 105 including, for example, a cabin for users of the vehicle 105. The interior of the vehicle 105 may include seats for the users, a steering mechanism, accelerator interface, braking interface, etc. The interior of the vehicle may include one or more interior vehicle sensors such as imaging sensors, tactile sensors, audio sensors, etc. configured to capture sensor data of vehicle occupants. The interior of the vehicle 105 may include a display device such as a display screen associated with an infotainment system, as further described with respect to FIG. 3.

The vehicle 105 may include a vehicle exterior. The vehicle exterior may include the outer surface of the vehicle 105. The vehicle exterior may include one or more lighting elements (e.g., headlights, brake lights, accent lights). The vehicle 105 may include one or more doors for accessing the vehicle interior by, for example, manipulating a door handle of the vehicle exterior. The vehicle 105 may include one or more windows, including a windshield, door windows, passenger windows, rear windows, sunroof, etc. The vehicle 105 may include one or more sensors for detecting the surrounding environment the vehicle 105. For instance, the vehicle 105 may include one or more camera sensors, temperature/weather sensors, tactile sensors, etc. to objects or conditions within the surrounding environment of the vehicle 105.

The systems and components of the vehicle 105 may be configured to communicate via a communication channel. The communication channel may include one or more data buses (e.g., controller area network (CAN)), on-board diagnostics connector (e.g., OBD-II), or a combination of wired or wireless communication links. The onboard systems may send or receive data, messages, signals, etc. amongst one another via the communication channel.

In an embodiment, the communication channel may include a direct connection, such as a connection provided via a dedicated wired communication interface, such as a RS-232 interface, a universal serial bus (USB) interface, or via a local computer bus, such as a peripheral component interconnect (PCI) bus. In an embodiment, the communication channel may be provided via a network. The network may be any type or form of network, such as a personal area network (PAN), a local-area network (LAN), Intranet, a metropolitan area network (MAN), a wide area network (WAN), or the Internet. The network may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol.

In an embodiment, the systems/devices of the vehicle 105 may communicate via an intermediate storage device, or more generally an intermediate non-transitory computer-readable medium. For example, the non-transitory computer-readable medium 140, which may be external to the computing system, may act as an external buffer or repository for storing information. In such an example, the computing system may retrieve or otherwise receive the information from the non-transitory computer-readable medium 140.

Certain routine and conventional components of vehicle 105 (e.g., an engine) are not illustrated and/or discussed herein for the purpose of brevity. One of ordinary skill in the art will understand the operation of conventional vehicle components in vehicle 105.

The vehicle 105 may include a vehicle computing system 200. As described herein, the vehicle computing system 200 is onboard the vehicle 105. For example, the computing devices and components of the vehicle computing system 200 may be housed, located, or otherwise included on or within the vehicle 105. The vehicle computing system 200 may be configured to execute the computing functions and operations of the vehicle 105. The computing system 200 may include one or more small language models (SLMs) as described herein. For example, the computing system 200 can access (e.g., from the remote computing platform 110, from the third-party computing platform 125, and/or from the user device 115) an SLM that the vehicle computing system can prune, heal/recover, quantize, etc., as described herein.

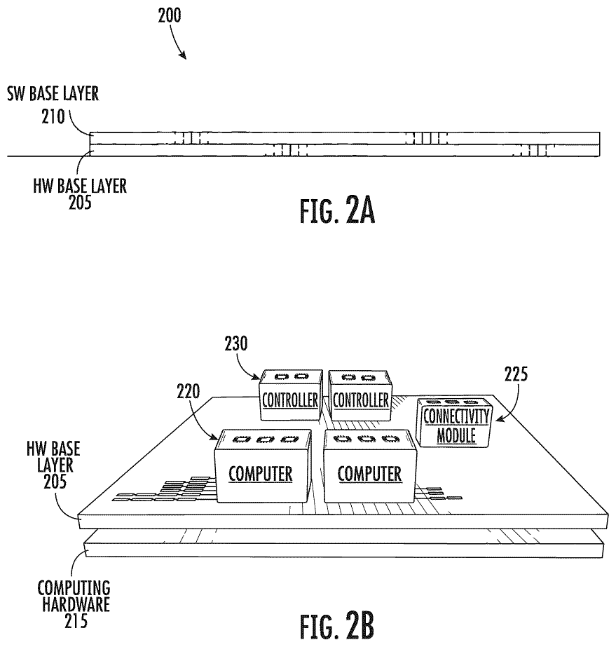

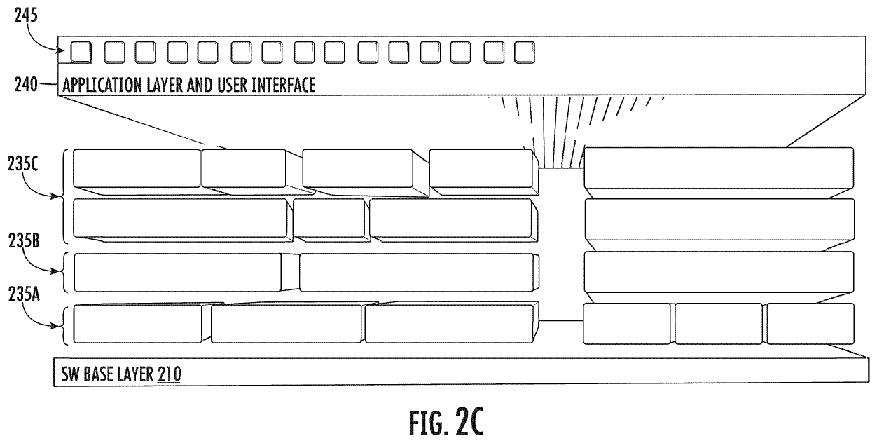

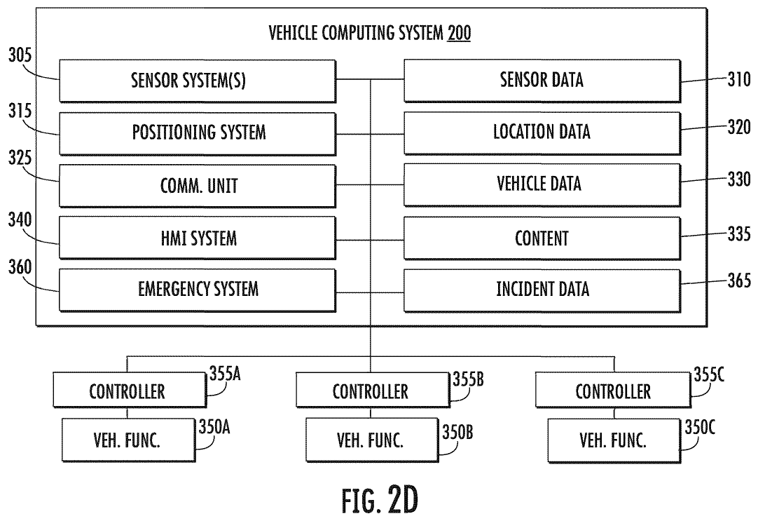

FIG. 2A illustrates an overview of an operating system of the vehicle computing system 200. The operating system may be a layered operating system. The vehicle computing system 200 may include a hardware layer 205 and a software layer 210. The hardware and software layers 205, 210 may include sub-layers. In some implementations, the operating system of the vehicle computing system 200 may include other layers (e.g., above, below, or in between those shown in FIG. 2A). In an example, the hardware layer 205 and the software layer 210 can be standardized base layers of the vehicle's operating system.

FIG. 2B illustrates a diagram of the hardware layer 205 of the vehicle computing system 200. In the layered operating system of the vehicle computing system 200, the hardware layer 205 can reside between the physical computing hardware 215 onboard the vehicle 105 and the software (e.g., of software layer 210) that runs onboard the vehicle 105.

The hardware layer 205 may be an abstraction layer including computing code that allows for communication between the software and the computing hardware 215 in the vehicle computing system 200. For example, the hardware layer 205 may include interfaces and calls that allow the vehicle computing system 200 to generate a hardware-dependent instruction to the computing hardware 215 (e.g., processors, memories, etc.) of the vehicle 105.

The hardware layer 205 may be configured to help coordinate the hardware resources. The architecture of the hardware layer 205 may be serviced oriented. The services may help provide the computing capabilities of the vehicle computing system 200. For instance, the hardware layer 205 may include the domain computers 220 of the vehicle 105, which may host various functionality of the vehicle 105 such as the vehicle's intelligent functionality. The specification of each domain computer may be tailored to the functions and the performance requirements where the services are abstracted to the domain computers. By way of example, this permits certain processing resources (e.g., graphical processing units) to support the functionality of a central in-vehicle infotainment computer for rendering graphics across one or more display devices for navigation, games, etc. or to support an intelligent automated driving computer to achieve certain industry assurances.

The hardware layer 205 may be configured to include a connectivity module 225 for the vehicle computing system 200. The connectivity module may include code/instructions for interfacing with the communications hardware of the vehicle 105. This can include, for example, interfacing with a communications controller, receiver, transceiver, transmitter, port, conductors, or other hardware for communicating data/information. The connectivity module 225 may allow the vehicle computing system 200 to communicate with other computing systems that are remote from the vehicle 105 including, for example, remote computing platform 110 (e.g., an OEM cloud platform).

The architecture design of the hardware layer 205 may be configured for interfacing with the computing hardware 215 for one or more vehicle control units 230. The vehicle control units 230 may be configured for controlling various functions of the vehicle 105. This may include, for example, a central exterior and interior controller (CEIC), a charging controller, or other controllers as further described herein.

The software layer 210 may be configured to provide software operations for executing various types of functionality and applications of the vehicle 105. For example, the software layer 210 may store one or more SLMs described herein, which may be modified (e.g., pruned, recovered, quantized, fine-tuned, etc.).

FIG. 2C illustrates a diagram of the software layer 210 of the vehicle computing system 200. The architecture of the software layer 210 may be service oriented and may be configured to provide software for various functions of the vehicle computing system 200. To do so, the software layer 210 may include a plurality of sublayers 235A-E. For instance, the software layer 210 may include a first sublayer 235A including firmware (e.g., audio firmware) and a hypervisor, a second sublayer 235B including operating system components (e.g., open-source components), and a third sublayer 235C including middleware (e.g., for flexible integration with applications developed by an associated entity or third-party entity).

The vehicle computing system 200 may include an application layer 240. The application layer 240 may allow for integration with one or more software applications 245 that are downloadable or otherwise accessible by the vehicle 105. The application layer 240 may be configured, for example, using containerized applications developed by a variety of different entities. By way of example, the application layer 240 may include containerized LLMs.

The layered operating system and the vehicle's onboard computing resources may allow the vehicle computing system 200 to collect and communicate data as well as operate the systems implemented onboard the vehicle 105.

FIG. 2D illustrates a block diagram of example systems and data of the vehicle 105. The vehicle 105 may include one or more sensor systems 305. These sensor systems may provide information and/or otherwise communicate with the one or more SLMs described herein. Additionally or alternatively, a sensor system 305 may include or otherwise be in communication with a sensor of the vehicle 105 and a module for processing sensor data 310 associated with the sensor configured to acquire the sensor data 305. This may include sensor data 310 associated with the surrounding environment of the vehicle 105, sensor data associated with the interior of the vehicle 105, or sensor data associated with a particular vehicle function. The sensor data 310 may be indicative of conditions observed in the interior of the vehicle, exterior of the vehicle, or in the surrounding environment. For instance, sensors of the vehicle 105 may include exterior sensors for detecting objects or motion within a surrounding environment of the vehicle 105. Sensor data 310 may include image data, data indicative of a vehicle occupant (e.g., user 120, etc.) within or outside the vehicle 105, positions of a user/object within a threshold distance of the vehicle 105, motion/gesture data, audio data, temperature data, tactile data, or other types of data. The sensors may include one or more: cameras (e.g., visible spectrum cameras, infrared cameras), motion sensors, tactile sensors, audio sensors (e.g., microphones), weight sensors (e.g., for a vehicle a seat), temperature sensors, humidity sensors, Light Detection and Ranging (LIDAR) systems, Radio Detection and Ranging (RADAR) systems, or other types of sensors.

The vehicle 105 may include a positioning system 315. The positioning system 315 may be configured to generate location data 320 (also referred to as position data) indicative of a location (also referred to as a position) of the vehicle 105. For example, the positioning system 315 may determine location by using one or more of inertial sensors (e.g., inertial measurement units, etc.), a satellite positioning system, based on IP address, by using triangulation and/or proximity to network access points or other network components (e.g., cellular towers, WiFi access points, etc.), or other suitable techniques. The positioning system 315 may determine a current location of the vehicle 105. The location may be expressed as a set of coordinates (e.g., latitude, longitude), an address, a semantic location (e.g., “at work”), etc.

In an embodiment, the positioning system 315 may be configured to localize the vehicle 105 within its environment. For example, the vehicle 105 may access map data that provides detailed information about the surrounding environment of the vehicle 105. The map data may provide information regarding: the identity and location of different roadways, road segments, buildings, or other items; the location and directions of traffic lanes (e.g., the location and direction of a parking lane, a turning lane, a bicycle lane, or other lanes within a particular roadway); traffic control data (e.g., the location, timing, or instructions of signage (e.g., stop signs, yield signs), traffic lights (e.g., stop lights), parking restrictions, or other traffic signals or control devices/markings (e.g., cross walks)); or any other data. The positioning system 315 may localize the vehicle 105 within the environment (e.g., across multiple axes) based on the map data. For example, the positioning system 155 may process certain sensor data 310 (e.g., LIDAR data, camera data, etc.) to match it to a map of the surrounding environment to get an understanding of the vehicle's position within that environment. The determined position of the vehicle 105 may be used by various systems of the vehicle computing system 200 or another computing system (e.g., the remote computing platform 110, the third-party computing platform 125, the user device 115).

The vehicle 105 may include a communications unit 325 configured to allow the vehicle 105 (and its vehicle computing system 200) to communicate with other computing devices. The vehicle computing system 200 may use the communications unit 325 to communicate with the user device 115 or one or more other remote computing devices over a network 130 (e.g., via one or more wireless signal connections). For example, the vehicle computing system 200 may utilize the communications unit 325 to transmit prompts and receive output responses from the LLM systems remote from the vehicle 105 and/or any SLM systems local to the vehicle 105 (e.g., stored in the vehicle computing system 200). This may include, for example, one or more prompts, modified prompts etc. transmitted (e.g., over the one or more networks 130) and one or more output responses associated with actions executable by the vehicle computing system 200. For instance, the output response may include, but is not limited to emitting an audio response via one or more vehicle speakers, generating/updating a user interface display within the vehicle 105, adjusting a temperature setting within the vehicle 105, providing an entertainment suggestion, providing a destination suggestion, adjusting a comfort setting with the vehicle 105, etc. An example of vehicle user interface displays is further described with reference to FIG. 3.

Additionally, or alternatively, the vehicle computing system 200 may utilize the communications unit 325 to send vehicle data 335 (e.g., prompts, modified prompts, context data etc.) to the user device 115. The vehicle data 335 may include any data acquired onboard the vehicle 105 including, for example, sensor data 310, location data 320, user input data, or other types of data obtained (e.g., acquired, accessed, generated, downloaded, etc.) by the vehicle computing system 200. For instance, LLMs and/or SLMs accessible to the user device 115 may be used to process prompts from the user 120.

In some implementations, the communications unit 325 may allow communication among one or more of the systems on-board the vehicle 105.

In an embodiment, the communications unit 325 may utilize various communication technologies such as, for example, Bluetooth low energy protocol, radio frequency signaling, or other short range or near filed communication technologies. The communications unit 325 may include any suitable components for interfacing with one or more networks, including, for example, transmitters, receivers, ports, controllers, antennas, or other suitable components that may help facilitate communication.

The vehicle 105 may include one or more human-machine interfaces (HMIs) 340. The human-machine interfaces 340 may include a display device, as described herein. The display device (e.g., touchscreen) may be viewable by a user of the vehicle 105 (e.g., user 120) that is located in the front of the vehicle 105 (e.g., driver's seat, front passenger seat). Additionally, or alternatively, a display device (e.g., rear unit) may be viewable by a user that is located in the rear of the vehicle 105 (e.g., back passenger seats). The human-machine interfaces 340 may present content via a user interface for display to a user 120.

FIG. 3 illustrates an example vehicle interior 300 with a display device 345. The display device 345 may be a component of the vehicle's infotainment system. Such a component may be referred to as a display device of the infotainment system or be considered as a device for implementing an embodiment that includes the use of an infotainment system. For illustrative and example purposes, such a component may be referred to herein as a head unit display device (e.g., positioned in a front/dashboard area of the vehicle interior), a rear unit display device (e.g., positioned in the back passenger area of the vehicle interior), an infotainment head unit or rear unit, or the like. The display device 345 may be located on, form a portion of, or function as a dashboard of the vehicle 105. The display device 345 may include a display screen, CRT, LCD, plasma screen, touch screen, TV, projector, tablet, and/or other suitable display components.

The display device 345 may display a variety of content to the user 120 including information about the vehicle 105, prompts for user input, outputs in response to user prompts, etc. The display device 345 may include a touchscreen through which the user 120 may provide user input to a user interface.

For example, the display device 345 may include user interface rendered via a touch screen that presents various content. The content may include vehicle speed, mileage, fuel level, charge range, navigation/routing information, audio selections, streaming content (e.g., video/image content), internet search results, comfort settings (e.g., temperature, humidity, seat position, seat massage), or other vehicle data 335. The display device 345 may render content to facilitate the receipt of user input. For instance, the user interface of the display device 345 may present one or more soft buttons with which a user 120 can interact to adjust various vehicle functions (e.g., navigation, audio/streaming content selection, temperature, seat position, seat massage, etc.). Additionally, or alternatively, the display device 345 may be associated with an audio input device (e.g., microphone) for receiving audio input from the user 120.

Returning to FIG. 2D, the vehicle 105 may include an emergency system 360. The emergency system 360 may be configured to obtain incident data 365. The incident data 365 may be indicative of an incident event including the vehicle 105. For example, the incident data 365 may include sensor data 310 from one or more sensors such as an airbag sensor, an impact sensor configured to detect an impact to the vehicle 105 by another object, a sensor configured to detect damaged vehicle components, a sensor configured to detect broken wired or wireless connections, etc. The incident event may include an accident, collision with an object (e.g., other vehicle, tree, guard rail), an unsafe vehicle maneuver (e.g., rollover, swerve offroad), etc. In some implementations, the emergency system 360 may be included in the communications system 325.

The vehicle 105 may include a plurality of vehicle functions 350A-C. A vehicle function 350A-C may be a functionality that the vehicle 105 is configured to perform based on a detected input. For example, the functionality may be performed in response to SLM outputs described herein. The vehicle functions 350A-C may include one or more: (i) vehicle comfort functions; (ii) vehicle staging functions; (iii) vehicle climate functions; (vi) vehicle navigation functions; (v) drive style functions; (v) vehicle parking functions; or (vi) vehicle entertainment functions. The (vi) vehicle entertainment functions may include playing music playlists or interactions with a travel companion. A travel companion can include a virtual or digital system such as a voice assistant that engages in communications with the vehicle occupants during the duration of a drive. For instance, the user 120 may interact with a vehicle function 250A-C through user input (e.g., to voice prompt) that specifies a setting of the vehicle function 250A-C such as the (i) vehicle entertainment function causing an SLM running within the vehicle computing system 200 or remote from the vehicle computing system 200 to engage in a dialogue with the vehicle occupants.

In an embodiment, the vehicle functions 350A-C may be functionality implemented in response to a model output (e.g., SLM output, LLM output) based on a prompt or modified prompt from a vehicle occupant. For instance, the vehicle owner may request, via a voice command, suggestions for dinner. A context engine may capture context data associated with one or more conditions of the voice command and generate a modified voice command that is transmitted to and processed by an SLM and/or LLM. For example, the SLM may return an output response that is implemented as a vehicle function 350A-C. An example of a context engine facilitating modified voice commands is further described with reference to FIGS. 6-9.

Each vehicle function may include a controller 355A-C associated with that particular vehicle function 350A-C. The controller 355A-C for a particular vehicle function may include control circuitry configured to operate its associated vehicle function 350A-C. For example, a controller may include circuitry configured to unlock a door, turn on the ignition, turn the seat heating function on, to turn the seat heating function off, set a particular temperature or temperature level, etc. The controllers 355A-C can be vehicle control modules that modify one or more physical systems, such as a state of locking of a door, state of ignition of the vehicle, state of car seat heating, etc.

In an embodiment, a controller 355A-C for a particular vehicle function may include or otherwise be associated with a sensor that captures data indicative of the vehicle function being turned on or off, a setting of the vehicle function, etc. For example, a sensor may be an audio sensor or a motion sensor. The audio sensor may be a microphone configured to capture audio input from the user 120. For example, the user 120 may provide a voice command to activate the radio function of the vehicle 105 and request a particular station. The motion sensor may be a visual sensor (e.g., camera), infrared, RADAR, etc. configured to capture a gesture input from the user 120. For example, the user 120 may provide a hand gesture motion to adjust a temperature function of the vehicle 105 to lower the temperature of the vehicle interior.

The controllers 355A-C may be configured to send signals to another onboard system. The signals may encode data associated with a respective vehicle function. The encoded data may indicate, for example, a function setting, timing, etc. In an example, such data may be used to generate content for presentation via the display device 345 (e.g., showing a current setting). In another example, such data may be used to by a context engine to supplement user behaviors such as voice prompts with additional context. Additionally, or alternatively, such data can be included in vehicle data 335 and transmitted to the remote computing platform 110.

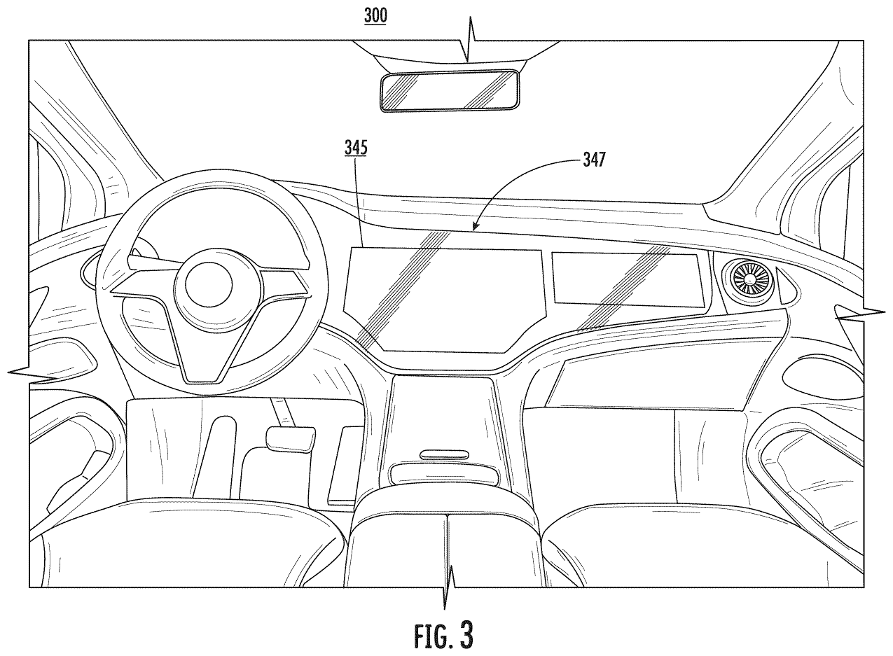

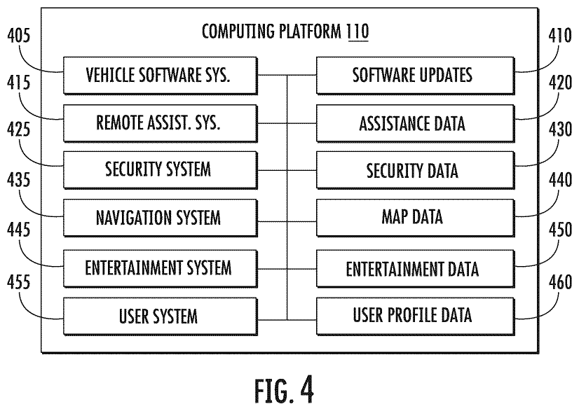

FIG. 4 illustrates a diagram of computing platform 110, which is remote from a vehicle according to an embodiment hereof. As described herein, the computing platform 110 may include a cloud-based computing platform.

In some implementations, the computing platform 110 may be implemented on a server, combination of servers, or a distributed set of computing devices which communicate over a network (e.g., network 130). For instance, the computing platform 110 may be distributed using one or more physical servers, private servers, or cloud computing. In some examples, the computing platform 110 may be implemented as a part of or in connection with one or more microservices, where, for example, an application is architected into independent services that communicate over APIs. Microservices may be deployed in a container (e.g., standalone software package for a software application) using a container service, or on VMs (virtual machines) within a shared network. Example, microservices may include a microservice associated with the vehicle software system 405, remote assistance system 415, etc. A container service may be a cloud service that allows developers to upload, organize, run, scale, manage, and stop containers using container-based virtualization to orchestrate their respective actions. A VM may include virtual computing resources which are not limited to a physical computing device. In some examples, the computing platform 110 may include or access one or more data stores for storing data associated with the one or more microservices. For instance, data stores may include distributed data stores, fully managed relational, NoSQL, and in-memory databases, etc.

The computing platform 110 may include a remote assistance system 415. The remote assistance system 415 may provide assistance to the vehicle 105. This can include providing information to the vehicle 105 to assist with charging (e.g., charging locations recommendations), remotely controlling the vehicle 105 (e.g., for AV assistance), remotely accessing the vehicle 105 (e.g., remote authorizations), roadside assistance (e.g., for collisions, flat tires), etc. The remote assistance system 415 may obtain assistance data 420 to provide its core functions. The assistance data 420 may include information that may be helpful for the remote assistance system 415 to assist the vehicle 105. This may include information related to the vehicle's current state, an occupant's current state, the vehicle's location, the vehicle's route, charge/fuel level, incident data, etc. In some implementations, the assistance data 420 may include the vehicle data 335.

The remote assistance system 415 may transmit data or command signals to provide assistance to the vehicle 105. This may include providing data indicative of relevant charging locations, remote control commands to move the vehicle, personalized recommendations, etc.

The computing platform 110 may include a security system 425. The security system 425 can be associated with one or more security-related functions for accessing the computing platform 110 or the vehicle 105. For instance, the security system 425 can process security data 430 for identifying vehicle occupancy, data encryption, data decryption, etc. for accessing the services/systems of the computing platform 110. Additionally, or alternatively, the security system 425 can store security data 430 associated with the vehicle 105. A user 120 can request authorization to access or operate the vehicle 105 (e.g., by approaching the vehicle 105, touching the vehicle, voice commands, etc.). In the event the user 120 has a magnetic key for the vehicle 105 as indicated in the security data 430, the security system 425 can provide a signal to perform one or more vehicle functions 350A-C based on a predetermined authorization profile associated with the magnetic key.

The computing platform 110 may include a navigation system 435 that provides a back-end routing and navigation service for the vehicle 105. The navigation system 435 may provide map data 440 to the vehicle 105. The map data 440 may be utilized by the positioning system 315 of the vehicle 105 to determine a location of the vehicle 105, a point of interest, etc. The navigation system 435 may also provide routes to destinations requested by the vehicle 105 (e.g., via user input to the vehicle's head unit). The routes can be provided as a portion of the map data 440 or as separate routing data. Data provided by the navigation system 435 can be presented as content on the display device 345 of the vehicle 105. In an embodiment, personalized destinations may be determined by the navigation system 435 based on output responses from an SLM and/or LLM. For instance, a context engine may detect additional context indicating conditions associated with a request for suggested destination. The context engine may facilitate personalized responses by communicating with an SLM and/or LLM to generate an output response that considers the additional context. The output response can be implemented by causing the navigation system 435 to provide routes to personalized destinations that consider the additional context.

The computing platform 110 may include an entertainment system 445. The entertainment system 445 may access one or more databases for entertainment data 450 for a user 120 of the vehicle 105. In some implementations, the entertainment system 445 may access entertainment data 450 from another computing system associated with a third-party service provider of entertainment content. The entertainment data 450 may include media content such as music, videos, gaming data, etc. The entertainment data 450 may be provided to vehicle 105, which may output the entertainment data 450 as content via one or more output devices of the vehicle 105 (e.g., display device, speaker, etc.). In an embodiment, the entertainment system 445 may facilitate a travel companion experience for the user 120 during the duration of a trip.

The computing platform 110 may include a user system 455. The user system 455 may create, store, manage, or access user profile data 460. The user profile data 460 may include a plurality of user profiles, each associated with a respective user 120. A user profile may indicate various information about a respective user 120 including the user's preferences (e.g., for music, comfort settings, parking preferences), frequented/past destinations, past routes, etc. The user profiles may be stored in a secure database. In some implementations, when a user 120 enters the vehicle 105, the user's key (or user device 115) may provide a signal with a user or key identifier to the vehicle 105.

The vehicle 105 may transmit data indicative of the identifier (e.g., via its communications system 325) to the computing platform 110. The computing platform 110 may look-up the user profile of the user 120 based on the identifier and transmit user profile data 460 to the vehicle computing system 200 of the vehicle 105. The vehicle computing system 200 may utilize the user profile data 460 to implement preferences of the user 120, present past destination locations, etc. In an embodiment, the user profile data 460 may be used by a context engine to generate modified prompts which considers the preferences of the user 120. The user profile data 460 may be updated based on information periodically provided by the vehicle 105. In some implementations, the user profile data 460 may be provided to the user device 115.

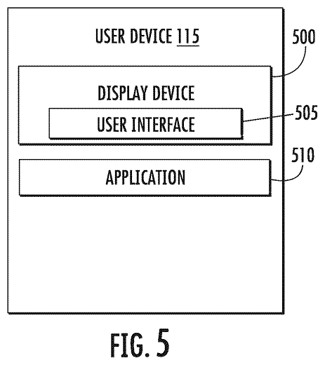

FIG. 5 illustrates a diagram of example components of user device 115 according to an embodiment hereof. The user device 115 may include a display device 500 configured to render content via a user interface 505 for presentation to a user 120. The display device 500 may include a display screen, AR glasses lens, smart watch, CRT, LCD, plasma screen, touch screen, TV, projector, tablet, or other suitable display components. The user device 115 may include a software application 510 that is downloaded and runs on the user device 115. In some implementations, the software application 510 may be associated with the vehicle 105 or an entity associated with the vehicle 105 (e.g., manufacturer, retailer, maintenance provider). In an example, the software application 510 may enable the user device 115 to communicate with the computing platform 110 and the services thereof.

The user device 115 may be configured to pair with the vehicle 105 via a short-range wireless protocol. The short-range wireless protocol may include, for example, at least one of Bluetooth®, Wi-Fi, ZigBee, UWB, IR. The user device 115 may pair with the vehicle 105 through one or more known pairing techniques. For example, the user device 115 and the vehicle 105 may exchange information (e.g., IP addresses, device names, profiles) and store such information in their respective memories. Pairing may include an authentication process whereby the user 120 validates the connection between the user device 115 and the vehicle 105. In some examples, the user device 115 may be configured to pair with the vehicle 105 over one or more networks 130 such as the internet. For instance, the user device 115 may be remote from the vehicle 105 and pair with the vehicle 105 over a network 130.

Once paired, the vehicle 105 and the user device 115 may exchange signals, data, etc. through the established communication channel. For example, the head unit 347 of the vehicle 105 may exchange signals with the user device 115.

The technology of the present disclosure allows the vehicle computing system 200 to preserve its computing resources by obtaining sensor data 305 and utilizing a context engine to generate personalized prompts. The personalized prompts may be input into one or more machine-learned models (e.g., SLMs) to generate personalized output responses for users 120. This allows the user 120 to provide prompts or hands free commands to the vehicle 105 and experience a personalized action. Examples described herein reference a vehicle owner as a vehicle occupant that may prompt a digital voice assistant within the vehicle 105. This is meant for example purposes only and is not meant to be limiting. Other parties associated with the vehicle 105 may provide prompts and other forms of communicating prompts may be used. This can include users 120 that are outside the vehicle, users 120 that type messages via the user device 115, display device 345, etc. or communicate using gestures such as sign language, etc. For instance, the user 120 may provide prompts via the user device 115.

As described herein, this technology can mitigate inefficiencies arising from the use of compressed or quantized model representations that degrade model precision and contextual integrity during inference. For example, certain SLMs deployed on edge devices may operate under memory or bandwidth constraints that necessitate quantization or pruning, resulting in loss of representational accuracy and reduced contextual fidelity. This can cause inconsistencies or artifacts in downstream task execution when model outputs are sensitive to fine-grained parameter relationships. The present disclosure enables retention of semantic and functional coherence within reduced-precision models by adaptively managing quantization ranges, preserving context across inference cycles, and compensating for pruning-induced distortions. Through these mechanisms, even highly compressed SLMs can maintain output quality comparable to full-precision models while operating efficiently within edge or embedded environments.

FIG. 6 illustrates an example dataflow pipeline 600 according to an embodiment hereof. As described above, the vehicle computing system 200 may include one or more processors, memory, and/or specialized control circuitry configured to process natural-language inputs and to generate corresponding outputs that may trigger or inform in-vehicle functions. For example, the vehicle computing system 200 may use outputs as further training examples for updating the inference systems described herein. In some implementations, the vehicle computing system 200 may operate independently of external network connectivity, thereby supporting function-calling capabilities even in the absence of cloud-based resources. The following description of dataflow in data pipeline 600 is described with an example implementation in which a vehicle computing system 200 processes vehicle data 335 from the vehicle 105 and causes one or more SLMs to implement actions within the vehicle 105 for the user 120 or other vehicle occupants. The vehicle data 335 may include real-time data and/or training data. Example real-time data may include data captured by one or more sensors placed throughout the vehicle interior 300. Training data may include pre-trained dataset from commercially available fine-tuned LLMs with automotive-specific vocabular, scenarios, etc.

The initial SLM 655 or any other modified version of the SLM may be software running on one or more servers. For instance, the context engine 610 may include software running on one or more servers within the vehicle computing system 200. In an embodiment, the initial SLM 655 may include a standalone system that communicates with the vehicle 105 over a wired or wireless local network. The initial SLM 655 may include one or more machine-learned models that process vehicle data 335 to generate output indicative of modified prompts 645 which can be processed by response generation models 650.

The vehicle computing system 200 may access an initial small language model (SLM) 655. The initial SLM 655 may be a pretrained transformer-based model designed to perform general-purpose language understanding tasks. Such a model may include multiple layers of hidden states, attention heads, and/or intermediate representations optimized during pretraining on a large-scale text corpus. The initial SLM 655 may serve as a base model from which a compressed, quantized, and/or otherwise optimized runtime model is derived for in-vehicle operation. The initial SLM 655 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The vehicle computing system 200 may prune the initial SLM 655 through one or more pruning operations 660. The pruning operations 660 may include depth-wise pruning, width-wise pruning, or a combination thereof, each designed to remove redundant or low-contribution parameters. Depth-wise pruning may include removing one or more layers of the model that exhibit high redundancy or similar output characteristics with adjacent layers. Width-wise pruning may include removing one or more attention heads and/or neurons within a layer. The width-wide pruning may be based on a minimum activation magnitude threshold and/or minimum contribution threshold to model performance. These pruning operations 660 may generate a compressed SLM that has reduced memory sufficient to be stored locally on the vehicle computing system 200.

In some implementations, pruning may be based on an analysis of similarity between model layers. For example, the vehicle computing system 200 may determine a degree of similarity between hidden state outputs of two or more layers of the pretrained SLM 655. Such similarity may be quantified by computing an angular distance and/or cosine similarity between respective layer representations. If one or more layers are determined to produce substantially similar activations, one or more of the layer(s) may be removed or merged.

Additionally or alternatively, the vehicle computing system 200 may determine attention head activation magnitudes. The vehicle computing system 200 may determine which (if any) attention heads exhibit a contribution to the model's contextual representation that is below a minimum activation magnitude. Any such layer may be removed to further reduce computational load. The vehicle computing system 200 may determine the thresholds by empirical analysis and/or adaptive optimization procedures. Additionally or alternatively the thresholds may be set manually.

Following pruning, the vehicle computing system 200 may initiate one or more model recovery operations 665. Model recovery 665 may be configured to restore linguistic coherence, factual accuracy, and/or other representational capabilities that may have been degraded by the pruning process. Such consistency can mitigate discontinuities and/or artifacts introduced by the model pruning 660.

The vehicle computing system 200 may then conduct model recovery (SFT) 670. Model recovery 670 may include supervised fine-tuning (SFT) on curated text datasets. The SFT process may expose the compressed model to general and/or task-specific queries. The model recovery (SFT) 670 can allow the compressed/pruned model to update its internal parameters to recover factual precision and/or linguistic fluency. Using model recovery (SFT) 670, the pruned SLM may regain coherence within a coherence threshold (e.g., 80%, 90%, etc.) compared to that of the initial SLM 655 while maintaining a reduced computational footprint suitable for in-vehicle deployment.

In some embodiments, the model recovery (SFT) 670 can include training through the use of one or more model trainers and/or training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include labeled segments that have labels indicating realistic, unrealistic, fanciful, etc. In some examples, the training data may include simulated or synthetic training data (e.g., synthetic data 680) (e.g., training data obtained from simulated scenarios, inputs, configurations, various acoustic settings, etc.). In some examples, the training may include reinforcement learning for refining command recognition accuracy. Other examples may include using hyperparameters such as learning rate, batch size, and/or optimizing epochs using grid search and Bayesian optimization techniques.

Additionally, or alternatively, the model trainer(s) may perform unsupervised training techniques using unlabeled training data. By way of example, the model trainer(s) may train one or more components of a machine-learned model to perform voice detection and voice analysis through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, and/or other techniques.

The vehicle computing system 200 may generate and/or align function-calling tokens 675 corresponding to specific vehicle operations. Each function-calling token may map to an internal and/or external application programming interface (API) and/or remote procedure call (RPC) endpoint associated with one or more subsystems of the vehicle 105. These tokens may enable the SLM to translate natural-language user inputs into structured control commands interpretable by the vehicle computing system 200.

In some embodiments, the vehicle computing system 200 may generate a synthetic dataset 680 comprising positive and negative examples of in-vehicle commands. Additionally or alternatively, the synthetic dataset 680 may be generated on a separate computing system, such as a cloud-based computing platform (e.g., the computing platform 110 and/or the third-party computing platform 125). Positive examples may correspond to valid control requests, such as “increase cabin temperature” or “turn on seat heating,” whereas negative examples may represent unsupported or ambiguous requests. The synthetic dataset 680 may be used to fine-tune and/or align the SLM to respond correctly to valid function-calling intents while rejecting unsupported or fanciful inputs.

In some embodiments, the vehicle computing system 200 may convert the compressed SLM into a quantized runtime format. Additionally or alternatively, the compressed SLM may be converted into the quantized runtime format using a separate computing system, such as a cloud-based and/or otherwise networked computing system (e.g., the computing platform 110 and/or the third-party computing platform 125). Quantization may involve reducing the numerical precision of the model parameters, such as by representing weights using fewer than a threshold number of bits per parameter (e.g., less than eight bits per parameter). This quantized representation may significantly reduce memory and bandwidth requirements during inference while maintaining model accuracy above a threshold model accuracy (e.g., above 90%, above 95%, above 99%). The quantized runtime format may be optimized for execution on vehicle-grade hardware, such as embedded GPUs, NPUs, or dedicated AI accelerators.

The quantized SLM, once deployed within the vehicle computing system 200, may process natural-language user inputs locally and generate corresponding function-calling outputs without relying on network connectivity. These outputs may then be executed by one or more vehicle control modules to adjust or modify physical systems of the vehicle 105, including seat heating, ambient lighting, and/or climate control. For example, the vehicle control modules may include one or more of the controllers 355A-C of FIG. 2D. The vehicle control modules can modify one or more physical systems of the vehicle.

In some embodiments, the vehicle computing system 200 may process audio data corresponding to natural-language user inputs. The vehicle computing system 200 may receive an acoustic signal representing a user prompt and perform voice activity detection, speech-to-text conversion, and/or speaker identification. For instance, one or more microphones positioned throughout the vehicle interior may capture the user prompt from a driver or other occupant. The vehicle computing system 200 may then identify the speaker and associate the corresponding user prompt with a stored user profile. The user profile may include user preferences, previously executed function-calling histories, and/or context data such as preferred temperature settings or entertainment choices. This contextual information may be used to augment or refine the textual representation of the user prompt prior to processing by the SLM.

In some examples, the vehicle computing system 200 may apply a context engine to combine the transcribed user prompt with vehicle data and user profile context. The context engine may generate a modified prompt that supplements the original user prompt with additional metadata representing environmental or user-specific factors (e.g., driver identity, seat position, climate control state). This modified prompt may then be provided to the SLM to generate a structured output response. The SLM may, for example, interpret the contextualized input based on the quantized parameters to generate a function-calling output mapped to a corresponding vehicle API or remote procedure call (RPC).

The output response generated by the SLM may include executable instructions for one or more vehicle systems, such as adjusting temperature, activating seat heating, updating an infotainment display, and/or initiating an audio response through the vehicle's sound system. The response or output can include music recommendation, natural-speech synthesis, and/or image-rendering that cooperate with the SLM to produce multimodal responses. These models may employ architectures such as transformer-based neural networks, convolutional networks, or recurrent networks trained to operate efficiently under the quantized runtime format. The vehicle computing system 200 may route the resulting function-calling outputs to vehicle controllers configured to implement the requested physical or digital actions, thereby completing the closed-loop operation between user input, model inference, and system actuation.

Additionally or alternatively, the vehicle computing system 200 may be configured to update model parameters incrementally as new data becomes available from deployed devices. For example, the vehicle computing system 200 may locally compute parameter gradients and/or feature statistics based on recent in-vehicle usage data. Additionally or alternatively, the vehicle computing system 200 can periodically transmit anonymized and/or compressed update vectors to a coordinating node. The vehicle computing system 200 may adapt to device-specific environments, user behaviors, and/or sensor drift without reliance on any outside network or LLM. In some embodiments, the incremental updates may require a minimum confidence threshold, a minimum sampling rate, and/or a minimum available compute resources to prevent destabilization of the SLM. In some embodiments, updating the model may be performed via a network connection, such as via the cloud described above, and may include redeploying the model incrementally and/or fully on board via an update.

In some implementations, the vehicle computing system 200 can detect model drift. In response to detecting model drift, the vehicle computing system 200 can execute an autonomous recovery protocol. The vehicle computing system 200 can identify model drift by computing a statistical divergence between incoming data distributions and the SLM's training distribution, degradation in performance metrics. Additionally or alternatively, the drift may be determined by increasing error residuals beyond an adaptive threshold. Based on a determination of model drift, the vehicle computing system 200 may initiate model retraining, selective reweighting of recent samples, and/or rollback to a previously validated model checkpoint. Additionally or alternatively, the vehicle computing system 200 may identify a root cause of the degradation, such as data corruption, environmental shift, and/or concept drift. In some embodiments, evaluation, analysis, and/or model improvement discussed herein may occur offline and/or on the cloud. Additionally or alternatively, real and/or synthetic data may be used.

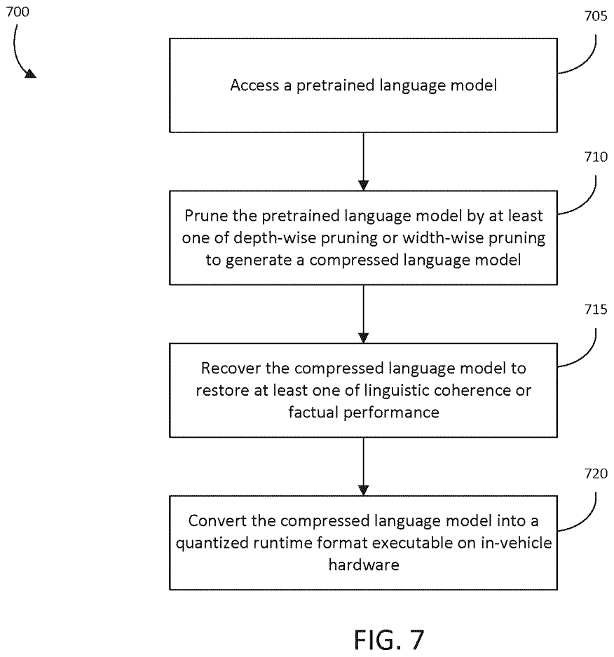

FIG. 7 illustrates a flowchart diagram of an example method 700 for in-vehicle function-calling using an SLM, according to an embodiment hereof. The method 700 may be performed by a computing system of a vehicle 105, such as the vehicle computing system 200 described herein. One or more operations of method 700 may be implemented as executable instructions stored in memory and executed by one or more processors of the vehicle computing system 200.

In an embodiment, the method 700 may begin with an operation 705: accessing a pretrained small language model. The pretrained small language model may include a transformer-based architecture comprising multiple layers, hidden states, and attention mechanisms optimized for general-purpose natural-language understanding. The pretrained small language model may be trained on a large-scale text corpus prior to deployment, and may serve as a base model from which an optimized in-vehicle model is derived. The pretrained small language model may be stored locally within the vehicle computing system 200 or may be retrieved from a remote repository during initialization.

The method 700 may include an operation 710: pruning the pretrained small language model by at least one of depth-wise pruning or width-wise pruning to generate a compressed small language model. Depth-wise pruning may include removing one or more layers determined to contribute redundant activations or similar contextual representations to adjacent layers. Width-wise pruning may include removing one or more attention heads or neurons within a layer based on low activation magnitudes or minimal contribution to overall model performance. The pruning process may additionally or alternatively include identifying and/or removing model components exhibiting high representational similarity. The model components to be removed may be determined by computing an angular distance and/or a cosine similarity between hidden states of adjacent layers.

The method 700 may further include an operation 715: recovering the compressed small language model to restore at least one of linguistic coherence or factual performance. Model recovery may include fine-tuning or retraining the pruned model on one or more general or domain-specific text datasets to restore coherence lost during pruning. Recovery may additionally or alternatively include performing fine-tuning to reintroduce consistency among model layers, attention heads, and/or intermediate representations. In some examples, supervised fine-tuning (SFT) 670 may be performed using labeled text datasets comprising task-specific commands and conversational patterns relevant to in-vehicle operation. Additionally or alternatively, the model recovery (SFT) 670 may be performed using general (e.g., non-task-specific) text datasets. This may help the model recovery (SFT) 670 to allow the recovered SLM to maintain linguistic and functional fidelity within a threshold of the original model performance. Model recovery can be configured to restore factual knowledge understanding and/or capability of following instructions when the model is prompted (e.g., during inference).

The method 700 may additionally or alternatively include an operation 720: converting the compressed small language model into a quantized runtime format executable on in-vehicle hardware for calling one or more functions. The in-vehicle hardware can include, for example, the hardware responsible for achieving the vehicle functions 350A-C of FIG. 2D, which may be controlled by controllers 355A-C. For example, in-vehicle hardware can include a door, an ignition, seat heaters, climate control elements, etc. Quantization may include reducing the numerical precision of one or more parameters, such as model weights and/or activations, to fewer than a threshold precision (e.g., 4 bit). The quantized model may be optimized for execution on embedded processors, neural processing units, or other specialized automotive hardware, allowing the SLM to perform natural-language processing efficiently under limited computational resources. The quantized runtime format may be stored within memory of the vehicle computing system 200 and loaded for inference during vehicle operation.

In some embodiments, method 700 may further include generating function-calling tokens corresponding to one or more vehicle operations. Each token may map to an internal or external application programming interface (API) or remote procedure call (RPC) endpoint associated with the vehicle computing system 200. The system may generate a synthetic dataset 680 that includes positive examples of valid in-vehicle commands and/or negative examples representing unsupported or ambiguous requests. The dataset may be used to align the compressed SLM with permissible vehicle control actions and to reject nonsensical or unauthorized requests. Function-calling alignment 675 may thereby enable the quantized model to translate natural-language user inputs into executable commands for vehicle subsystems, such as seat heating, ambient lighting, or climate control.

The quantized small language model may locally process natural-language prompts and generate corresponding function-calling outputs without requiring network connectivity. These outputs may be transmitted to one or more vehicle controllers for execution, thereby allowing the vehicle computing system 200 to perform in-vehicle operations based on user intent through an optimized and efficient language processing pipeline.

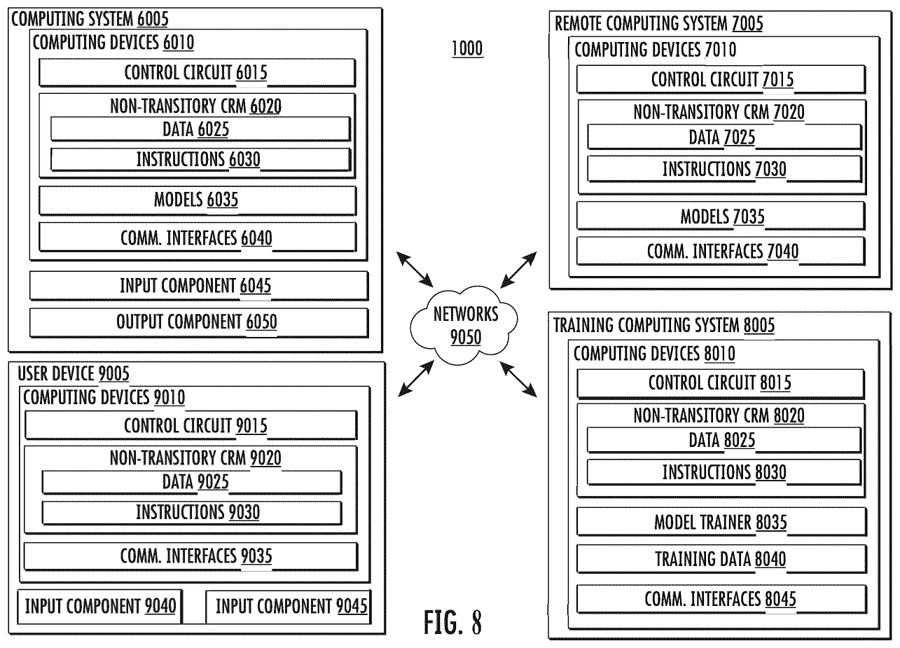

FIG. 8 illustrates a block diagram of an example computing system 1000 according to an embodiment hereof. The system 1000 includes a computing system 6005 (e.g., a computing system onboard a vehicle), a remote computing system 7005 (e.g., computing platform 110), a user device 9005 (e.g., user device 115), and a training computing system 8005 that are communicatively coupled over one or more networks 9050.

The computing system 6005 may include one or more computing devices 6010 or circuitry. For instance, the computing system 6005 may include a control circuit 6015 and a non-transitory computer-readable medium 6020, also referred to herein as memory. In an embodiment, the control circuit 6015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 6015 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a charging controller, a central exterior & interior controller (CEIC), a zone controller, or any other controller. In an embodiment, the control circuit 6015 may be programmed by one or more computer-readable or computer-executable instructions stored on the non-transitory computer-readable medium 6020.

In an embodiment, the non-transitory computer-readable medium 6020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 6020 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 6020 may store information that may be accessed by the control circuit 6015. For instance, the non-transitory computer-readable medium 6020 (e.g., memory devices) may store data 6025 that may be obtained, received, accessed, written, manipulated, created, and/or stored. The data 6025 may include, for instance, any of the data or information described herein. In some implementations, the computing system 6005 may obtain data from one or more memories that are remote from the computing system 6005.

The non-transitory computer-readable medium 6020 may also store computer-readable instructions 6030 that may be executed by the control circuit 6015. The instructions 6030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 6015 to perform one or more functional tasks. The modules and computer-readable/executable instructions may be described as performing various operations or tasks when the control circuit 6015 or other hardware component is executing the modules or computer-readable instructions.

The instructions 6030 may be executed in logically and/or virtually separate threads on the control circuit 6015. For example, the non-transitory computer-readable medium 6020 may store instructions 6030 that when executed by the control circuit 6015 cause the control circuit 6015 to perform any of the operations, methods and/or processes described herein. In some cases, the non-transitory computer-readable medium 6020 may store computer-executable instructions or computer-readable instructions, such as instructions to perform at least a portion of the method of FIG. 7.

In an embodiment, the computing system 6005 may store or include one or more machine-learned models 6035. For example, the machine-learned models 6035 may be or may otherwise include various machine-learned models, including any of the machine-learned models described herein. In an embodiment, the machine-learned models 6035 may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models). As another example, the machine-learned models 6035 can include generative models, such as stable diffusion models, generative adversarial networks (GAN), GPT models, and other suitable models.

In an aspect of the present disclosure, the models 6035 may be used to collect and translate contextual information associated with commands received from a user (e.g., user 120) to personalize actions taken within the vehicle (e.g., vehicle 105). For example, the machine-learned models 6035 can, in response to sensor data 310 generate context data indicating one or more conditions associated with a prompt from the user 120. The models 6035 may utilize the context data to generate personalized output responses.

In an embodiment, the one or more machine-learned models 6035 may be received from the remote computing system 7005 over networks 9050, stored in the computing system 6005 (e.g., non-transitory computer-readable medium 6020), and then used or otherwise implemented by the control circuit 6015. In an embodiment, the computing system 6005 may implement multiple parallel instances of a single model.

Additionally, or alternatively, one or more machine-learned models 6035 may be included in or otherwise stored and implemented by the remote computing system 7005 that communicates with the computing system 6005 according to a client-server relationship. For example, the machine-learned models 6035 may be implemented by the remote computing system 7005 as a portion of a web service. Thus, one or more models 6035 may be stored and/or implemented (e.g., as models 7035) at the computing system 6005 and/or one or more models 6035 may be stored and implemented at the remote computing system 7005.

The computing system 6005 may include one or more communication interfaces 6040. The communication interfaces 6040 may be used to communicate with one or more other systems. The communication interfaces 6040 may include any circuits, components, software, etc. for communicating via one or more networks (e.g., networks 9050). In some implementations, the communication interfaces 6040 may include for example, one or more of a communications controller, receiver, transceiver, transmitter, port, conductors, software and/or hardware for communicating data/information.

The computing system 6005 may also include one or more user input components 6045 that receives user input. For example, the user input component 6045 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The computing system 6005 may include one or more output components 6050. The output components 6050 may include hardware and/or software for audibly or visually producing content. For instance, the output components 6050 may include one or more speakers, earpieces, headsets, handsets, etc. The output components 6050 may include a display device, which may include hardware for displaying a user interface and/or messages for a user. By way of example, the output component 6050 may include a display screen, CRT, LCD, plasma screen, touch screen, TV, projector, tablet, and/or other suitable display components.

The remote computing system 7005 may include one or more computing devices 7010. In an embodiment, the remote computing system 7005 may include or is otherwise implemented by one or more computing devices onboard an autonomous drone. In instances in which the remote computing system 7005 includes computing devices within cloud infrastructure, such computing devices may operate according to sequential computing architectures, parallel computing architectures, or some combination thereof.

The remote computing system 7005 may include a control circuit 7015 and a non-transitory computer-readable medium 7020, also referred to herein as memory 7020. In an embodiment, the control circuit 7015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 7015 may be programmed by one or more computer-readable or computer-executable instructions stored on the non-transitory computer-readable medium 7020.

In an embodiment, the non-transitory computer-readable medium 7020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 7020 may store information that may be accessed by the control circuit 7015. For instance, the non-transitory computer-readable medium 7020 (e.g., memory devices) may store data 7025 that may be obtained, received, accessed, written, manipulated, created, and/or stored. The data 7025 may include, for instance, any of the data or information described herein. In some implementations, the server system 7005 may obtain data from one or more memories that are remote from the server system 7005.

The non-transitory computer-readable medium 7020 may also store computer-readable instructions 7030 that may be executed by the control circuit 7015. The instructions 7030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 7015 to perform one or more functional tasks. The modules and computer-readable/executable instructions may be described as performing various operations or tasks when the control circuit 7015 or other hardware component is executing the modules or computer-readable instructions.

The instructions 7030 may be executed in logically and/or virtually separate threads on the control circuit 7015. For example, the non-transitory computer-readable medium 7020 may store instructions 7030 that when executed by the control circuit 7015 cause the control circuit 7015 to perform any of the operations, methods and/or processes described herein. In some cases, the non-transitory computer-readable medium 7020 may store computer-executable instructions or computer-readable instructions, such as instructions to perform at least a portion of the method of FIG. 7.

The remote computing system 7005 may include one or more communication interfaces 7040. The communication interfaces 7040 may be used to communicate with one or more other systems. The communication interfaces 7040 may include any circuits, components, software, etc. for communicating via one or more networks (e.g., networks 7050). In some implementations, the communication interfaces 7040 may include for example, one or more of a communications controller, receiver, transceiver, transmitter, port, conductors, software and/or hardware for communicating data/information.

The computing system 6005 and/or the remote computing system 7005 may train the models 6035, 7035 via interaction with the training computing system 8005 that is communicatively coupled over the networks 9050. The training computing system 8005 may be separate from the remote computing system 7005 or may be a portion of the remote computing system 7005.

The training computing system 8005 may include one or more computing devices 8010. In an embodiment, the training computing system 8005 may include or is otherwise implemented by one or more server computing devices. In instances in which the training computing system 8005 includes plural server computing devices, such server computing devices may operate according to sequential computing architectures, parallel computing architectures, or some combination thereof.

The training computing system 8005 may include a control circuit 8015 and a non-transitory computer-readable medium 8020, also referred to herein as memory 8020. In an embodiment, the control circuit 8015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 8015 may be programmed by one or more computer-readable or computer-executable instructions stored on the non-transitory computer-readable medium 8020.

In an embodiment, the non-transitory computer-readable medium 8020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 8020 may store information that may be accessed by the control circuit 8015. For instance, the non-transitory computer-readable medium 8020 (e.g., memory devices) may store data 8025 that may be obtained, received, accessed, written, manipulated, created, and/or stored. The data 8025 may include, for instance, any of the data or information described herein. In some implementations, the training computing system 8005 may obtain data from one or more memories that are remote from the training computing system 8005.

The non-transitory computer-readable medium 8020 may also store computer-readable instructions 8030 that may be executed by the control circuit 8015. The instructions 8030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 8015 to perform one or more functional tasks. The modules and computer-readable/executable instructions may be described as performing various operations or tasks when the control circuit 8015 or other hardware component is executing the modules or computer-readable instructions.

The instructions 8030 may be executed in logically or virtually separate threads on the control circuit 8015. For example, the non-transitory computer-readable medium 8020 may store instructions 8030 that when executed by the control circuit 8015 cause the control circuit 8015 to perform any of the operations, methods and/or processes described herein. In some cases, the non-transitory computer-readable medium 8020 may store computer-executable instructions or computer-readable instructions, such as instructions to perform at least a portion of the methods of FIG. 7.

The training computing system 8005 may include a model trainer 8035 that trains the machine-learned models 6035, 7035 stored at the computing system 6005 and/or the remote computing system 7005 using various training or learning techniques. For example, the models 6035, 7035 may be trained using a loss function that evaluates quality of generated samples over various characteristics, such as similarity to the training data.

The training computing system 8005 may modify parameters of the models 6035, 7035 based on the loss function (e.g., generative loss function) such that the models 6035, 7035 may be effectively trained for specific applications in a supervised manner using labeled data and/or in an unsupervised manner.

In an example, the model trainer 8035 may backpropagate the loss function through the user intent model 1002 to modify the parameters (e.g., weights) of the generative model (e.g., 620). The model trainer 8035 may continue to backpropagate the clustering loss function through the machine-learned model, with or without modification of the parameters (e.g., weights) of the model. For instance, the model trainer 8035 may perform a gradient descent technique in which parameters of the machine-learned model may be modified in a direction of a negative gradient of the clustering loss function. Thus, in an embodiment, the model trainer 8035 may modify parameters of the machine-learned model based on the loss function.

The model trainer 8035 may utilize training techniques, such as backwards propagation of errors. For example, a loss function may be backpropagated through a model to update one or more parameters of the models (e.g., based on a gradient of the loss function). Various loss functions may be used such as mean squared error, likelihood loss, cross entropy loss, hinge loss, and/or various other loss functions. Gradient descent techniques may be used to iteratively update the parameters over a number of training iterations.

In an embodiment, performing backwards propagation of errors may include performing truncated backpropagation through time. The model trainer 8035 may perform a number of generalization techniques (e.g., weight decays, dropouts, etc.) to improve the generalization capability of a model being trained. In particular, the model trainer 8035 may train the machine-learned models 6035, 7035 based on a set of training data 8040.

The training data 8040 may include unlabeled training data for training in an unsupervised fashion. Furthermore, in some implementations, the training data 8040 can include labeled training data for training in a supervised fashion. For example, the training data 8040 can be or can include the sensor data 310.

In an embodiment, if the user has provided consent/authorization, training examples may be provided by the computing system 6005 (e.g., of the user's vehicle). Thus, in such implementations, a model 6035 provided to the computing system 6005 may be trained by the training computing system 8005 in a manner to personalize the model 6035.

The model trainer 8035 may include computer logic utilized to provide desired functionality. The model trainer 8035 may be implemented in hardware, firmware, and/or software controlling a general-purpose processor. For example, in an embodiment, the model trainer 8035 may include program files stored on a storage device, loaded into a memory and executed by one or more processors. In other implementations, the model trainer 8035 may include one or more sets of computer-executable instructions that are stored in a tangible computer-readable storage medium such as RAM, hard disk, or optical or magnetic media.

The training computing system 8005 may include one or more communication interfaces 8045. The communication interfaces 8045 may be used to communicate with one or more other systems. The communication interfaces 8045 may include any circuits, components, software, etc. for communicating via one or more networks (e.g., networks 9050). In some implementations, the communication interfaces 8045 may include for example, one or more of a communications controller, receiver, transceiver, transmitter, port, conductors, software and/or hardware for communicating data/information.

The computing system 6005, the remote computing system 7005, and/or the training computing system 8005 may also be in communication with a user device 9005 that is communicatively coupled over the networks 9050.

The user device 9005 may include various types of user devices. This may include head-worn wearable devices (e.g., AR glasses, watches, etc.), handheld devices, tablets, or other types of devices.

The user device 9005 may include one or more computing devices 9010. The user device 9005 may include a control circuit 9015 and a non-transitory computer-readable medium 9020, also referred to herein as memory 9020. In an embodiment, the control circuit 9015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 9015 may be programmed by one or more computer-readable or computer-executable instructions stored on the non-transitory computer-readable medium 9020.

In an embodiment, the non-transitory computer-readable medium 9020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 9020 may store information that may be accessed by the control circuit 9015. For instance, the non-transitory computer-readable medium 9020 (e.g., memory devices) may store data 9025 that may be obtained, received, accessed, written, manipulated, created, and/or stored. The data 9025 may include, for instance, any of the data or information described herein. In some implementations, the user device 9005 may obtain data from one or more memories that are remote from the user device 9005.

The non-transitory computer-readable medium 9020 may also store computer-readable instructions 9030 that may be executed by the control circuit 9015. The instructions 9030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 9015 to perform one or more functional tasks. The modules and computer-readable/executable instructions may be described as performing various operations or tasks when the control circuit 9015 or other hardware component is executing the modules or computer-readable instructions.

The instructions 9030 may be executed in logically or virtually separate threads on the control circuit 9015. For example, the non-transitory computer-readable medium 9020 may store instructions 9030 that when executed by the control circuit 9015 cause the control circuit 9015 to perform any of the operations, methods and/or processes described herein. In some cases, the non-transitory computer-readable medium 9020 may store computer-executable instructions or computer-readable instructions, such as instructions to perform at least a portion of the method of FIG. 7.

The user device 9005 may include one or more communication interfaces 9035. The communication interfaces 9035 may be used to communicate with one or more other systems. The communication interfaces 9035 may include any circuits, components, software, etc. for communicating via one or more networks (e.g., networks 7050). In some implementations, the communication interfaces 9035 may include for example, one or more of a communications controller, receiver, transceiver, transmitter, port, conductors, software and/or hardware for communicating data/information.

The user device 9005 may also include one or more user input components 9040 that receives user input. For example, the user input component 9040 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input. In an embodiment, the input components 9040 may include audio and virtual components such as a microphone (e.g., voice commands), accelerometers/gyroscopes (e.g., physical commands), etc.

The user device 9005 may include one or more output components 9045. The output components 9045 may include hardware and/or software for audibly or visually producing content. For instance, the output components 9045 may include one or more speakers, earpieces, headsets, handsets, etc. The output components 9045 may include a display device, which may include hardware for displaying a user interface and/or messages for a user. By way of example, the output component 9045 may include a display screen, CRT, LCD, plasma screen, touch screen, TV, projector, tablet, and/or other suitable display components.

The one or more networks 9050 may be any type of communications network, such as a local area network (e.g., intranet), wide area network (e.g., Internet), or some combination thereof and may include any number of wired or wireless links. In general, communication over a network 9050 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

### ADDITIONAL DISCUSSION OF VARIOUS EMBODIMENTS

Embodiment 1 relates to a computer-implemented method for in-vehicle function-calling using a small language model, the method comprising: accessing a pretrained small language model; pruning the pretrained small language model by at least one of depth-wise pruning or width-wise pruning to generate a compressed small language model; recovering the compressed small language model to restore at least one of linguistic coherence or factual performance; and converting the compressed small language model into a quantized runtime format executable on in-vehicle hardware for calling one or more functions.

Embodiment 2 relates to the method of Embodiment 1, further comprising: determining a degree of similarity of output from at least two layers of the pretrained small language model.

Embodiment 3 relates to the method of Embodiment 2, wherein determining the degree of similarity of the output from at least two layers of the pretrained small language model comprises determining an angular distance between hidden states of the at least two layers of the pretrained small language model.

Embodiment 4 relates to the method of Embodiment 2, wherein pruning the pretrained small language model comprises removing, based on determining the degree of similarity of the output from the at least two layers of the pretrained small language model, at least one of the at least two layers from the pretrained small language model.

Embodiment 5 relates to the method of Embodiment 1, further comprising: determining a magnitude of activation of at least one attention head associated with one or more layers of the pretrained small language model.

Embodiment 6 relates to the method of Embodiment 5, wherein pruning the pretrained small language model comprises removing, based on determining the magnitude of activation of the at least one attention head associated with the one or more layers of the pretrained small language model, at least one of the one or more layers from the pretrained small language model.

Embodiment 7 relates to the method of Embodiment 1, wherein recovering the compressed small language model comprises retraining the compressed small language model on one or more general text datasets.

Embodiment 8 relates to the method of Embodiment 1, further comprising: generating special-function tokens each corresponding to a respective vehicle function.

Embodiment 9 relates to the method of Embodiment 8, wherein generating special-function tokens comprises generating a synthetic dataset comprising at least one of positive examples corresponding to valid in-vehicle commands or negative examples corresponding to unsupported requests.

Embodiment 10 relates to the method of Embodiment 9, wherein each of the special-function tokens is configured to map to a remote procedure call interface for a vehicle computing system.

Embodiment 11 relates to the method of Embodiment 9, wherein generating the special-function tokens comprises applying a low-rank adaptation to provide a higher specificity of domain.

Embodiment 12 relates to the method of Embodiment 1, further comprising: storing the compressed small language model locally within a vehicle to process natural-language user inputs to generate one or more function-calling outputs mapped to in-vehicle control commands.

Embodiment 13 relates to the method of Embodiment 1, wherein the generated one or more function-calling outputs are executable, in response to user inputs, by a vehicle control module to modify one or more physical systems.

Embodiment 14 relates to the method of Embodiment 13, wherein the one or more physical systems comprise at least one of: seat heating, ambient lighting, or climate control.

Embodiment 15 relates to the method of Embodiment 1, wherein converting the compressed small language model into the quantized runtime format comprises reducing a number of bits associated with one or more parameters of the compressed small language model to fewer than 8-bit.

Embodiment 16 relates to a vehicle computing system for in-vehicle function-calling using a small language model, the vehicle computing system comprising: control circuitry configured to: access a pretrained small language model; prune the pretrained small language model by at least one of depth-wise pruning or width-wise pruning to generate a compressed small language model; recover the compressed small language model to restore at least one of linguistic coherence or factual performance; and convert the compressed small language model into a quantized runtime format executable on in-vehicle hardware.

Embodiment 17 relates to the vehicle computing system of Embodiment 16, wherein the control circuitry is further configured to: determine a degree of similarity of output from at least two layers of the pretrained small language model.

Embodiment 18 relates to the vehicle computing system of Embodiment 16, wherein the control circuitry is further configured to: determine a magnitude of activation of at least one attention head associated with one or more layers of the pretrained small language model.

Embodiment 19 relates to the vehicle computing system of Embodiment 16, wherein recovering the compressed small language model comprises retraining the compressed small language model on one or more general text datasets.

Embodiment 20 relates to one or more non-transitory computer-readable media storing instructions executable by a control circuit to: access a pretrained language model; prune the pretrained small language model by at least one of depth-wise pruning or width-wise pruning to generate a compressed small language model; recover the compressed small language model to restore at least one of linguistic coherence or factual performance; and convert the compressed small language model into a quantized runtime format executable on in-vehicle hardware.

### Additional Disclosure

As used herein, adjectives and their possessive forms are intended to be used interchangeably unless apparent otherwise from the context and/or expressly indicated. For instance, “component of a/the vehicle” may be used interchangeably with “vehicle component” where appropriate. Similarly, words, phrases, and other disclosure herein is intended to cover obvious variants and synonyms even if such variants and synonyms are not explicitly listed.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, may readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment may be used with another embodiment to yield a still further embodiment. Thus, it is intended that the present disclosure cover such alterations, variations, and equivalents.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein may be adapted, rearranged, expanded, omitted, combined, or modified in various ways without deviating from the scope of the present disclosure. At times, elements may be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. may be performed before, after, or in parallel with another operation illustrated by a list identifier of (b), (ii), etc.

What is claimed is:

1. A computer-implemented method for in-vehicle function-calling using a small language model, the method comprising:
accessing a pretrained small language model;
pruning the pretrained small language model by at least one of depth-wise pruning or width-wise pruning to generate a compressed small language model;
recovering the compressed small language model to restore at least one of linguistic coherence or factual performance; and
converting the compressed small language model into a quantized runtime format executable on in-vehicle hardware for calling one or more functions.

2. The method of claim 1, further comprising:
determining a degree of similarity of output from at least two layers of the pretrained small language model.

3. The method of claim, wherein determining the degree of similarity of the output from at least two layers of the pretrained small language model comprises determining an angular distance between hidden states of the at least two layers of the pretrained small language model.

4. The method of claim, wherein pruning the pretrained small language model comprises removing, based on determining the degree of similarity of the output from the at least two layers of the pretrained small language model, at least one of the at least two layers from the pretrained small language model.

5. The method of claim 1, further comprising:
determining a magnitude of activation of at least one attention head associated with one or more layers of the pretrained small language model.

6. The method of claim, wherein pruning the pretrained small language model comprises removing, based on determining the magnitude of activation of the at least one attention head associated with the one or more layers of the pretrained small language model, at least one of the one or more layers from the pretrained small language model.

7. The method of claim 1, wherein recovering the compressed small language model comprises retraining the compressed small language model on one or more general text datasets.

8. The method of claim 1, further comprising:
generating special-function tokens each corresponding to a respective vehicle function.

9. The method of claim, wherein generating special-function tokens comprises generating a synthetic dataset comprising at least one of positive examples corresponding to valid in-vehicle commands or negative examples corresponding to unsupported requests.

10. The method of claim, wherein each of the special-function tokens is configured to map to a remote procedure call interface for a vehicle computing system.

11. The method of claim, wherein generating the special-function tokens comprises applying a low-rank adaptation to provide a higher specificity of domain.

12. The method of claim 1, further comprising:
storing the compressed small language model locally within a vehicle to process natural-language user inputs to generate one or more function-calling outputs mapped to in-vehicle control commands.

13. The method of claim 1, wherein the generated one or more function-calling outputs are executable, in response to user inputs, by a vehicle control module to modify one or more physical systems.

14. The method of claim, wherein the one or more physical systems comprise at least one of: seat heating, ambient lighting, or climate control.

15. The method of claim 1, wherein converting the compressed small language model into the quantized runtime format comprises reducing a number of bits associated with one or more parameters of the compressed small language model to fewer than 8-bit.

16. A vehicle computing system for in-vehicle function-calling using a small language model, the vehicle computing system comprising:
control circuitry configured to:
access a pretrained small language model;
prune the pretrained small language model by at least one of depth-wise pruning or width-wise pruning to generate a compressed small language model;
recover the compressed small language model to restore at least one of linguistic coherence or factual performance; and
convert the compressed small language model into a quantized runtime format executable on in-vehicle hardware.

17. The vehicle computing system of claim, wherein the control circuitry is further configured to:
determine a degree of similarity of output from at least two layers of the pretrained small language model.

18. The vehicle computing system of claim, wherein the control circuitry is further configured to:
determine a magnitude of activation of at least one attention head associated with one or more layers of the pretrained small language model.

19. The vehicle computing system of claim, wherein recovering the compressed small language model comprises retraining the compressed small language model on one or more general text datasets.

20. One or more non-transitory computer-readable media storing instructions executable by a control circuit to:
access a pretrained language model;
prune the pretrained small language model by at least one of depth-wise pruning or width-wise pruning to generate a compressed small language model;
recover the compressed small language model to restore at least one of linguistic coherence or factual performance; and
convert the compressed small language model into a quantized runtime format executable on in-vehicle hardware.
